(19) United States
(12) Patent Application Publication
(10) Pub. No.: US 2026/0281995 A1
(43) Pub. Date: Sep. 17, 2026

(54) FREQUENCY-DEPENDENT RESIDUAL SIDE BAND MITIGATION

(71) Applicant: QUALCOMM Incorporated, San Diego, CA (US)

(72) Inventors: Aviv REGEV, Tel Aviv (IL); Ronen SHAKED, Kfar Saba (IL); Amit BAR-OR TILLINGER, Tel-Aviv (IL); Gideon Shlomo KUTZ, Ramat Hasharon (IL); Amit MOSES, Tel Aviv (IL)

(21) Appl. No.: 19/076,220

(22) Filed: Mar. 11, 2025

(51) Int. Cl. H04W 72/0453; H04W 72/23; H04W 72/51

(52) U.S. Cl. CPC H04W 72/0453; H04W 72/23; H04W 72/51

(57) ABSTRACT

Various aspects of the present disclosure generally relate to wireless communication. In some aspects, a user equipment (UE) may receive, from a network node, a request for a plurality of frequency-dependent residual side band (FDRSB) reports. The UE may transmit, to the network node, a first report including a full FDRSB model associated with a first FDRSB estimation. The UE may transmit, to the network node, a second report including a partial FDRSB model associated with a second FDRSB estimation. Numerous other aspects are described.

### FIELD OF THE DISCLOSURE

Aspects of the present disclosure generally relate to wireless communication and specifically relate to techniques, apparatuses, and methods associated with frequency-dependent residual side band mitigation.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

In-phase and quadrature-phase (IQ) modulation is a technique that represents wireless signals using an in-phase (I) component and a quadrature-phase (Q) component. The I component and the Q component may be derived by dividing a carrier signal into two parts, with the in-phase component being in phase with a reference signal and the Q component being 90 degrees out of phase with the reference signal. IQ modulation enables the simultaneous modulation of both the amplitude and phase of a signal, which may be utilized in quadrature amplitude modulation (QAM) or orthogonal frequency division multiplexing (OFDM), among other examples.

### SUMMARY

Some aspects described herein relate to a user equipment (UE). The UE may include a processing system. The processing system may include one or more processors and one or more code-storing memories coupled with the one or more processors. The processing system may be configured to cause the UE to receive, from a network node, a request for a plurality of frequency-dependent residual side band (FDRSB) reports. The processing system may be configured to cause the UE to transmit, to the network node, a first report including a full FDRSB model associated with a first FDRSB estimation. The processing system may be configured to cause the UE to transmit, to the network node, a second report including a partial FDRSB model associated with a second FDRSB estimation.

Some aspects described herein relate to a network node. The network node may include a processing system. The processing system may include one or more processors and one or more code-storing memories coupled with the one or more processors. The processing system may be configured to cause the network node to transmit, to one or more UEs of a set of UEs, a request for a plurality of FDRSB reports. The processing system may be configured to cause the network node to receive, from each UE of the one or more UEs, a first report including a full FDRSB model associated with a first FDRSB estimation. The processing system may be configured to cause the network node to receive, from each UE of the one or more UEs, a second report including a partial FDRSB model associated with a second FDRSB estimation.

Some aspects described herein relate to a method of wireless communication performed by a UE. The method may include receiving, from a network node, a request for a plurality of FDRSB reports. The method may include transmitting, to the network node, a first report including a full FDRSB model associated with a first FDRSB estimation. The method may include transmitting, to the network node, a second report including a partial FDRSB model associated with a second FDRSB estimation.

Some aspects described herein relate to a method of wireless communication performed by a network node. The method may include transmitting, to one or more UEs of a set of UEs, a request for a plurality of FDRSB reports. The method may include receiving, from each UE of the one or more UEs, a first report including a full FDRSB model associated with a first FDRSB estimation. The method may include receiving, from each UE of the one or more UEs, a second report including a partial FDRSB model associated with a second FDRSB estimation.

Some aspects described herein relate to a non-transitory computer-readable medium that stores a set of instructions for wireless communication by a UE. The set of instructions, when executed by one or more processors of the UE, may cause the UE to receive, from a network node, a request for a plurality of FDRSB reports. The set of instructions, when executed by one or more processors of the UE, may cause the UE to transmit, to the network node, a first report including a full FDRSB model associated with a first FDRSB estimation. The set of instructions, when executed by one or more processors of the UE, may cause the UE to transmit, to the network node, a second report including a partial FDRSB model associated with a second FDRSB estimation.

Some aspects described herein relate to a non-transitory computer-readable medium that stores a set of instructions for wireless communication by a network node. The set of instructions, when executed by one or more processors of the network node, may cause the network node to transmit, to one or more UEs of a set of UEs, a request for a plurality of FDRSB reports. The set of instructions, when executed by one or more processors of the network node, may cause the network node to receive, from each UE of the one or more UEs, a first report including a full FDRSB model associated with a first FDRSB estimation. The set of instructions, when executed by one or more processors of the network node, may cause the network node to receive, from each UE of the one or more UEs, a second report including a partial FDRSB model associated with a second FDRSB estimation.

Some aspects described herein relate to an apparatus for wireless communication. The apparatus may include means for receiving, from a network node, a request for a plurality of FDRSB reports. The apparatus may include means for transmitting, to the network node, a first report including a full FDRSB model associated with a first FDRSB estimation. The apparatus may include means for transmitting, to the network node, a second report including a partial FDRSB model associated with a second FDRSB estimation.

Some aspects described herein relate to an apparatus for wireless communication. The apparatus may include means for transmitting, to one or more UEs of a set of UEs, a request for a plurality of FDRSB reports. The apparatus may include means for receiving, from each UE of the one or more UEs, a first report including a full FDRSB model associated with a first FDRSB estimation. The apparatus may include means for receiving, from each UE of the one or more UEs, a second report including a partial FDRSB model associated with a second FDRSB estimation.

The systems, methods, and devices of this disclosure each have several innovative aspects, no single one of which is solely responsible for the desirable attributes disclosed herein.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication network.

FIG. 2 is a diagram illustrating an example disaggregated network node architecture.

FIG. 3 is a diagram illustrating an example of frequency-dependent residual side band (FDRSB) impairment and FDRSB correction.

FIGS. 4A-4D are diagrams illustrating an example associated with FDRSB mitigation.

FIGS. 5A-5C are diagrams illustrating examples associated with FDRSB mitigation.

FIG. 6 is a diagram illustrating an example process performed, for example, at a user equipment (UE) or an apparatus of a UE.

FIG. 7 is a diagram illustrating an example process performed, for example, at a network node or an apparatus of a network node.

FIGS. 8-9 are diagrams of example apparatuses for wireless communication.

### DETAILED DESCRIPTION

In a wireless network, in-phase and quadrature-phase (IQ) modulation is a technique that represents wireless signals using an in-phase (I) component and a quadrature-phase (Q) component. The I component and the Q component may be derived by dividing a carrier signal into two parts, with the in-phase component being in phase with a reference signal and the Q component being 90 degrees out of phase with the reference signal. IQ modulation enables the simultaneous modulation of both the amplitude and phase of a signal.

In some examples, a mismatch between an I transmission chain and a Q transmission chain (referred to as an “IQ mismatch”) may cause a frequency-dependent residual side band (FDRSB) impairment. The FDRSB impairment may cause an undesired image (e.g., located at a mirror frequency) that may distort a transmission output signal. As a result, the mirror frequency may be associated with a noise threshold (e.g., a limiting noise floor) that could limit the link performance associated with the signal. For example, FDRSB impairment may cause decreased performance in transmissions that utilize relatively high-order modulation (e.g., 4k-quadrature amplitude modulation (QAM) or 16k-QAM, among other examples), which may be sensitive to a noise threshold (e.g., due to a relatively small tolerance for error vector magnitude (EVM)). Accordingly, FDRSB estimation and correction techniques may be utilized to suppress the noise threshold (e.g., the noise floor) associated with the FDRSB impairment.

In some examples, some receivers (e.g., a user equipment (UE)) may be capable of performing FDRSB estimation and FDRSB correction. For example, such receivers may include specific hardware components, mechanisms, or configurations that are capable of performing FDRSB estimation and correction. However, because the FDRSB estimation and correction mechanisms in these receivers may be capable of supporting a limited quantity of transmitters (e.g., each transmitter may have a different FDRSB impairment for estimation and correction), such receivers may be unable to perform FDRSB estimation and correction in certain multiple-input multiple-output (MIMO) scenarios (e.g., massive MIMO). Similarly, performing FDRSB estimation and correction at a receiver may result in increased power consumption and processing overhead. As a result, receiver-based FDRSB estimation and correction may be infeasible or unsupported in many UEs.

In some examples, a transmitter (e.g., a network node) may perform FDRSB estimation and correction. However, in order to perform FDRSB estimation and correction, the transmitter may dedicate transmitter hardware for each of one or more IQ modulator lanes. For example, the dedicated hardware may include a component associated with a radio frequency (RF) demodulator feedback chain, a component associated with sampling the RF demodulator feedback chain and performing an analog-to-digital conversion, and a component associated with digital FDRSB estimation, among other examples. As a result, performing FDRSB estimation and correction at the transmitter may result in increased power consumption and processing overhead, as well as a dedication of one or more hardware components to the FDRSB estimation and correction procedures.

Various aspects relate generally to federated distributed coding for over-the-air (OTA) FDRSB mitigation. For example, in this approach, multiple UEs may perform distributed FDRSB estimation based on pilot signals transmitted by the network node. Each UE may estimate the FDRSB impairment for its assigned frequency regions or antennas and transmit the estimation to the network node. Some aspects more specifically relate to a network node transmitting, to one or more UEs of a set of UEs, a request for a plurality of FDRSB reports. In some aspects, the one or more UEs may each transmit a first report including a full FDRSB model associated with a first FDRSB estimation, and the network node may perform FDRSB correction based on the first report from each of the one or more UEs. Additionally, the one or more UEs may each transmit a second report including a partial FDRSB model associated with a second FDRSB estimation, and the network node may perform further FDRSB correction based on the second report from each of the one or more UEs. Furthermore, each UE of the one or more UEs may transmit a plurality of additional reports (e.g., a third report, a fourth report, and so on), and each additional report may include an updated partial FDRSB model associated with additional FDRSB estimation. Additionally, the network node may perform further FDRSB corrections based on each of the additional reports.

In some aspects, one or more UEs, of the set of UEs, may each transmit, to the network node, a capability report indicating an FDRSB estimation capability associated with that UE. In some aspects, the UE may puncture the encoded second FDRSB estimation (e.g., or one or more additional estimations associated with a respective additional report of the plurality of additional reports) to generate the partial FDRSB model. Additionally, the partial FDRSB model may be associated with a set of parity bits that satisfy an entropy condition associated with the full FDRSB model.

Particular aspects of the subject matter described in this disclosure can be implemented to realize one or more of the following potential advantages. In some examples, the federated FDRSB mitigation approach allows for the combination of multiple UE estimations to create a comprehensive FDRSB model without requiring each UE to individually estimate the entire FDRSB impairment, thereby reducing the overall computational burden and power consumption on each UE and at the network node. For example, by performing FDRSB correction based on FDRSB estimation reports received from the one or more UEs, the network node may avoid performing FDRSB estimation, thereby reducing processing overhead and power consumption. Additionally, dividing FDRSB estimation across a plurality of UEs may reduce the power consumption associated with FDRSB estimation at each UE of the plurality of UEs. Similarly, where FDRSB estimation is performed by multiple UEs, each UE may experience an increase in processing gain or an increase in the quantity of supported estimation parameters, relative to FDRSB estimation being performed at a single UE, thereby resulting in increased FDRSB estimation accuracy. Furthermore, performing FDRSB correction at the network node (e.g., as opposed to at the UEs that perform FDRSB estimation) allows all UEs served by the network node to benefit from the FDRSB correction. For example, UEs that are not capable of FDRSB estimation (e.g., UEs that did not transmit FDRSB estimation reports to the network node) may benefit from the FDRSB correction performed at the network node. Additionally, due to the strong correlation between successive FDRSB estimations, subsequent updates are transmitted as partial models, which may reduce the uplink overhead by only transmitting the necessary information to update the existing model at the network node.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive MIMO, beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, RF sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

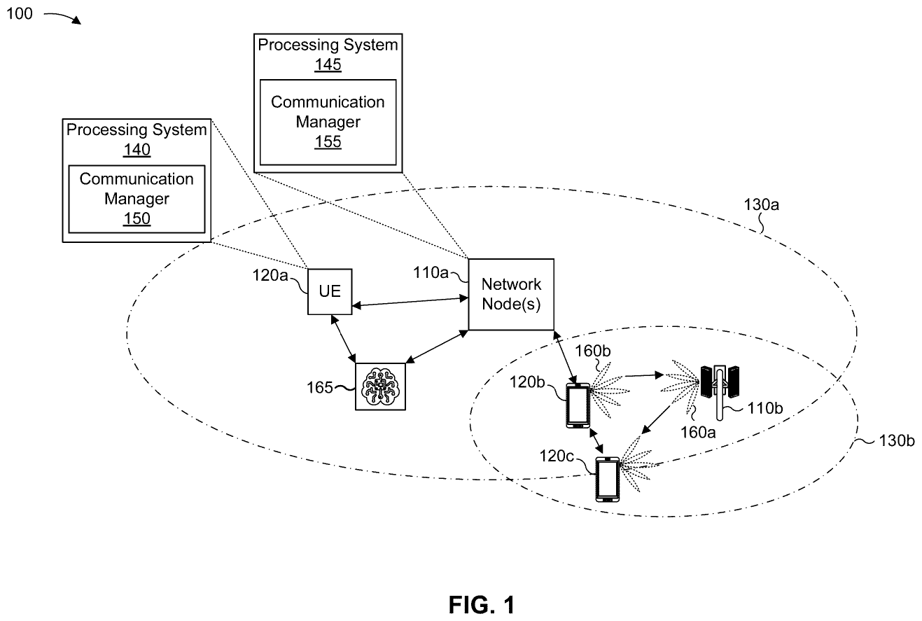

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHZ), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHZ), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, and as also shown, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle OTA communication with one or more UEs 120. In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (L1), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of QAM, such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples).

In some aspects, the UE 120 may include a communication manager 150. As described in more detail elsewhere herein, the communication manager 150 may receive, from a network node 110, a request for a plurality of FDRSB reports; transmit, to the network node 110, a first report including a full FDRSB model associated with a first FDRSB estimation; and transmit, to the network node 110, a second report including a partial FDRSB model associated with a second FDRSB estimation. Additionally, or alternatively, the communication manager 150 may perform one or more other operations described herein.

In some aspects, the network node 110 may include a communication manager 155. As described in more detail elsewhere herein, the communication manager 155 may transmit, to one or more UEs 120 of a set of UEs 120, a request for a plurality of FDRSB reports; receive, from each UE 120 of the one or more UEs 120, a first report including a full FDRSB model associated with a first FDRSB estimation; and receive, from each UE 120 of the one or more UEs 120, a second report including a partial FDRSB model associated with a second FDRSB estimation. Additionally, or alternatively, the communication manager 155 may perform one or more other operations described herein.

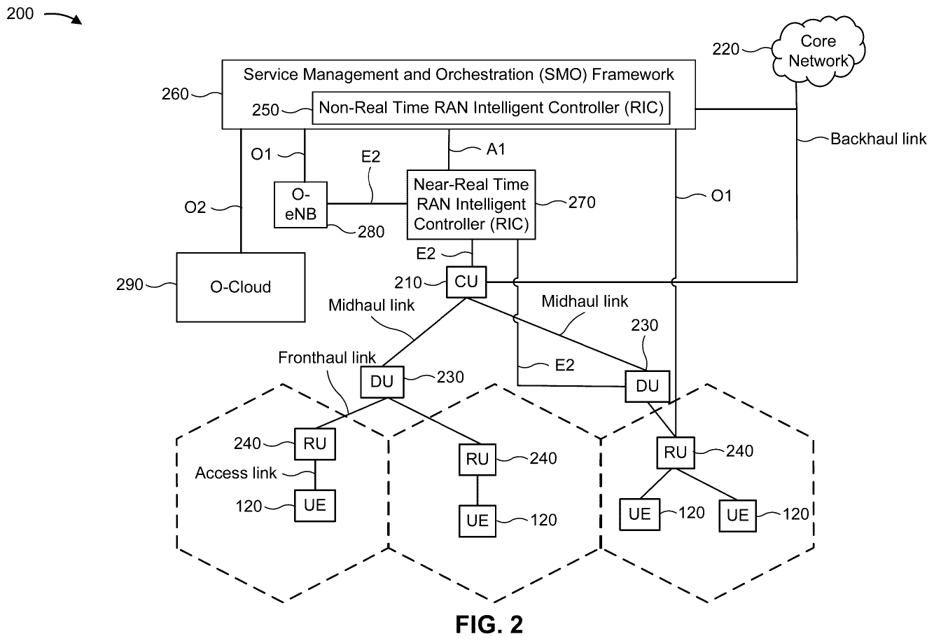

FIG. 2 is a diagram illustrating an example disaggregated network node architecture 200. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for transmitting or receiving signals, such as data, control information, or reference signals via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, or a Near-RT RIC 270. In some aspects, the SMO Framework 260 may communicate with a hardware aspect of a 4G RAN, a 5G NR RAN, or a 6G RAN, such as an open eNB (O-eNB) 280, via an O1 interface. Additionally, or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, or policy-based guidance of applications or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

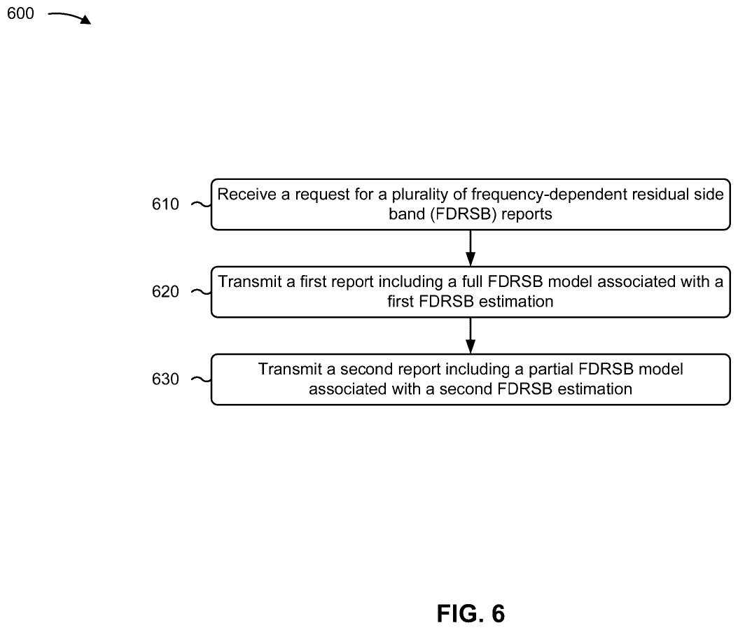

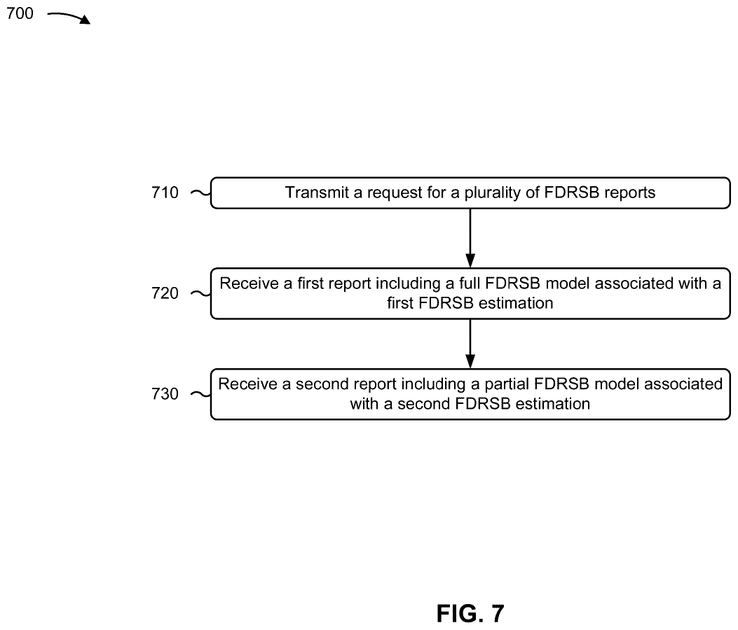

The network node 110, the processing system 145 of the network node 110, the UE 120, the processing system 140 of the UE 120, the CU 210, the DU 230, the RU 240, or any other component(s) of FIG. 1 or FIG. 2 may implement one or more techniques or perform one or more operations associated with FDRSB mitigation, as described in more detail elsewhere herein. For example, the processing system 145 of the network node 110, the processing system 140 of the UE 120, the CU 210, the DU 230, or the RU 240 may perform or direct operations of, for example, process 600 of FIG. 6, process 700 of FIG. 7 or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 600 of FIG. 6, process 700 of FIG. 7, or other processes as described herein. In some examples, executing instructions may include running the instructions, converting the instructions, compiling the instructions, or interpreting the instructions, among other examples.

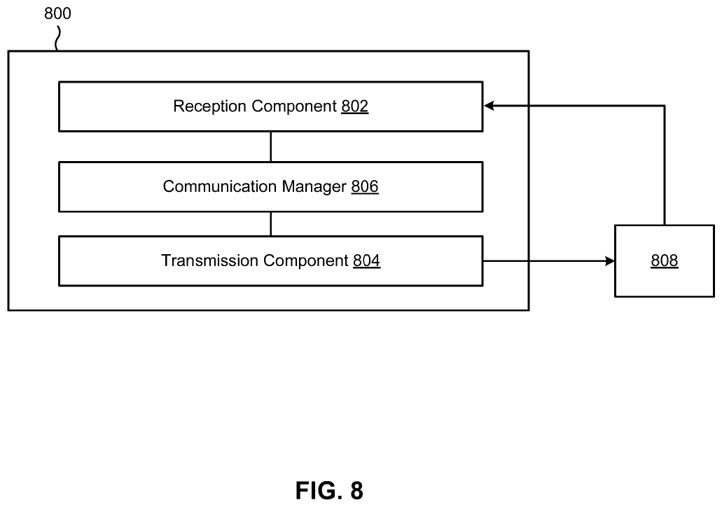

In some aspects, the UE 120 includes means for receiving, from a network node 110, a request for a plurality of FDRSB reports; means for transmitting, to the network node 110, a first report including a full FDRSB model associated with a first FDRSB estimation; or means for transmitting, to the network node 110, a second report including a partial FDRSB model associated with a second FDRSB estimation. The means for the UE 120 to perform operations described herein may include, for example, one or more of communication manager 150, processing system 140, a radio, one or more RF chains, one or more transceivers, one or more antennas, one or more modems, a reception component (for example, reception component 802 depicted and described in connection with FIG. 8), or a transmission component (for example, transmission component 804 depicted and described in connection with FIG. 8), among other examples.

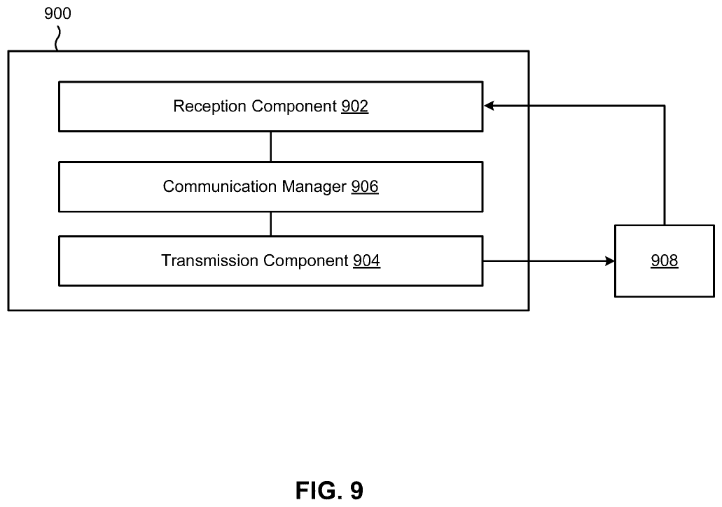

In some aspects, the network node 110 includes means for transmitting, to one or more UEs 120 of a set of UEs 120, a request for a plurality of FDRSB reports; means for receiving, from each UE 120 of the one or more UEs 120, a first report including a full FDRSB model associated with a first FDRSB estimation; or means for receiving, from each UE 120 of the one or more UEs 120, a second report including a partial FDRSB model associated with a second FDRSB estimation. The means for the network node 110 to perform operations described herein may include, for example, one or more of communication manager 155, processing system 145, a radio, one or more RF chains, one or more transceivers, one or more antennas, one or more modems, a reception component (for example, reception component 902 depicted and described in connection with FIG. 9), or a transmission component (for example, transmission component 904 depicted and described in connection with FIG. 9), among other examples.

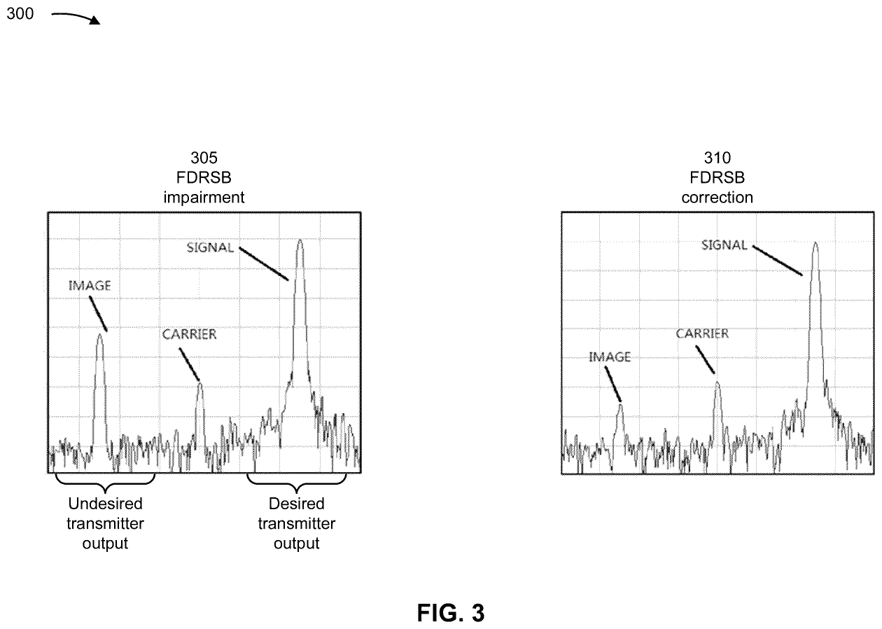

FIG. 3 is a diagram illustrating an example 300 of FDRSB impairment and FDRSB correction.

As shown by reference number 305, in some examples, a mismatch between an I transmission chain and a Q transmission chain (e.g., an IQ mismatch) may cause an FDRSB impairment. The FDRSB impairment may cause an undesired image (e.g., located at a mirror frequency) that may distort a transmission output signal. As a result, the mirror frequencies may be associated with a noise threshold (e.g., a limiting noise floor) that could limit the link performance associated with the signal. For example, FDRSB impairment may cause decreased performance in transmissions that utilize relatively high-order modulation (e.g., 4k-QAM or 16k-QAM, among other examples), which may be sensitive to a noise threshold (e.g., due to a relatively small tolerance for an EVM).

For example, the received signal with FDRSB impairment may be expressed as:

$$y ( f ) = H ( f ) ( s ( f ) {k}_{1} ( f ) + {s}^{*} ( - f ) {k}_{2} ( f ) ) + w ( f ) ,$$

where y(f) may denote a signal received at a receiver (e.g., a UE), H(f) may denote a channel, s(f)k₁(f) may denote a desired transmitter output, s*(−f)k₂(f) may denote an undesired transmitter output, and w(f) may denote noise.

As shown by reference number 310, FDRSB estimation and correction techniques may be utilized to suppress the noise threshold (e.g., the noise floor) associated with the FDRSB impairment, thereby reducing the impact of the undesired image. However, in massive MIMO configurations, each transmitter antenna may have a different FDRSB impairment, and the quantity of FDRSB impairments may increase linearly as a function of the quantity of antennas. For example, in a massive MIMO configuration, a relatively large quantity of transmission antennas may result in a relatively large quantity of IQ impairments associated with the transmitter. As a result, a network may utilize an increasing number of FDRSB estimation and correction mechanisms in order to correct the FDRSB impairment associated with each antenna.

In some examples, some receivers (e.g., a UE) may be capable of performing FDRSB estimation and FDRSB correction. For example, such receivers may include specific hardware components, mechanisms, or configurations that are capable of performing FDRSB estimation and correction. However, because the FDRSB estimation and correction mechanisms in these receivers may be capable of supporting a limited quantity of transmitters (e.g., each transmitter may have a different FDRSB impairment for estimation and correction), such receivers may be unable to perform FDRSB estimation correction in certain multiple-input multiple-output (MIMO) scenarios (e.g., massive MIMO). Additionally, in some examples, performing FDRSB estimation and correction at a receiver may result in increased power consumption and processing overhead. As a result, receiver-based FDRSB estimation and correction may be infeasible or unsupported in many UEs.

Furthermore, the ability of a receiver to perform FDRSB estimation and correction may be dependent on a bandwidth being allocated symmetrically around a center frequency associated with the signal and the image. Additionally, in some cases of frequency division multiplexing (FDM), FDRSB estimation and correction may be hindered due to a plurality of FDM signals interfering with one another. As a result, a UE that is capable of FDRSB estimation and correction may be further limited by network conditions or network configurations associated with the FDRSB impairment.

In some examples, a transmitter (e.g., a network node) may perform FDRSB estimation and correction. However, to perform FDRSB estimation and correction, the transmitter may dedicate transmitter hardware for each of one or more IQ modulator lanes. For example, the dedicated hardware may include a component associated with a RF demodulator feedback chain, a component associated with sampling the RF demodulator feedback chain and performing an analog-to-digital conversion, and a component associated with digital FDRSB estimation, among other examples. As a result, performing FDRSB estimation and correction at the transmitter may result in increased power consumption and processing overhead, as well as a dedication of one or more hardware components to the FDRSB estimation and correction procedures.

As indicated above, FIG. 3 is provided as an example. Other examples may differ from what is described with respect to FIG. 3.

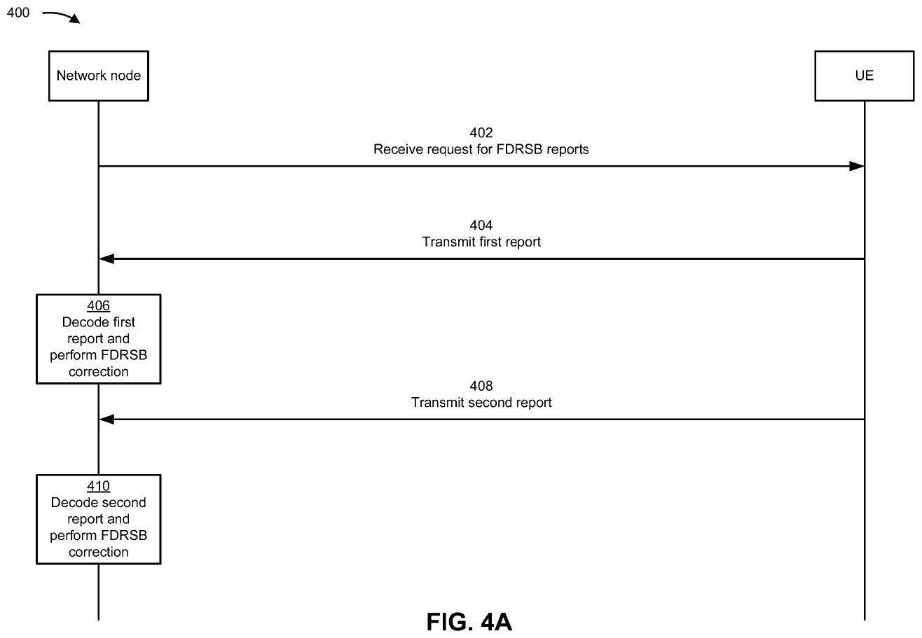

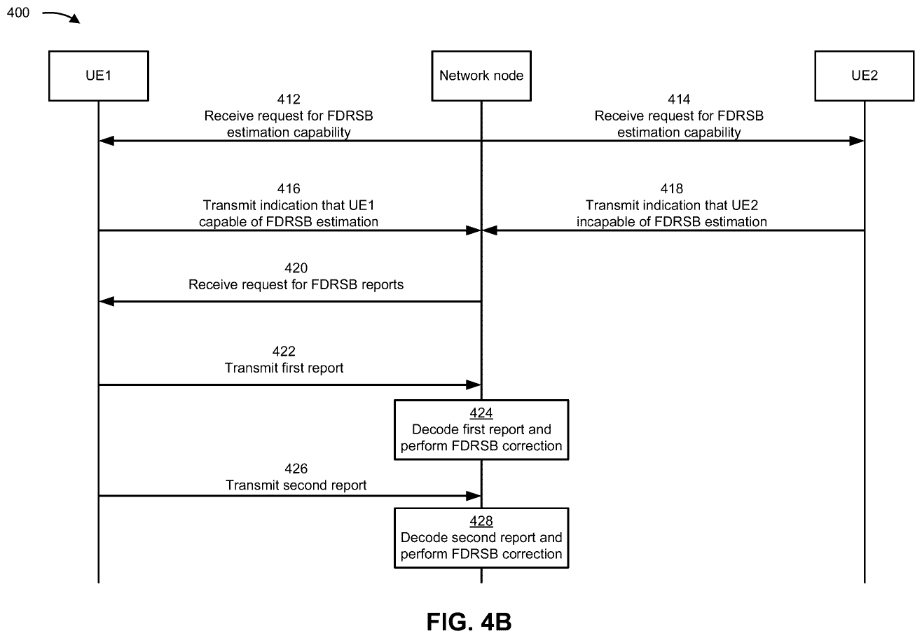

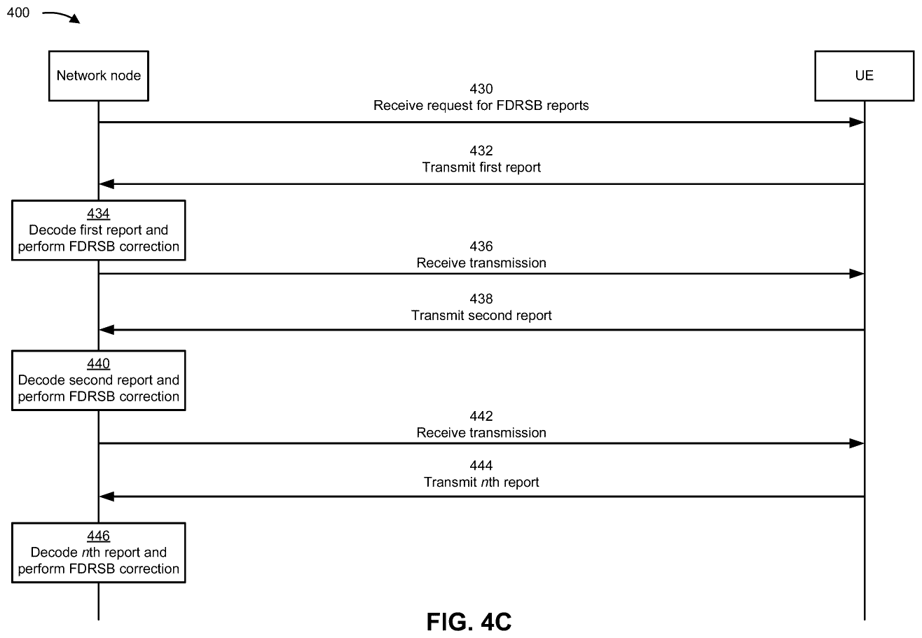

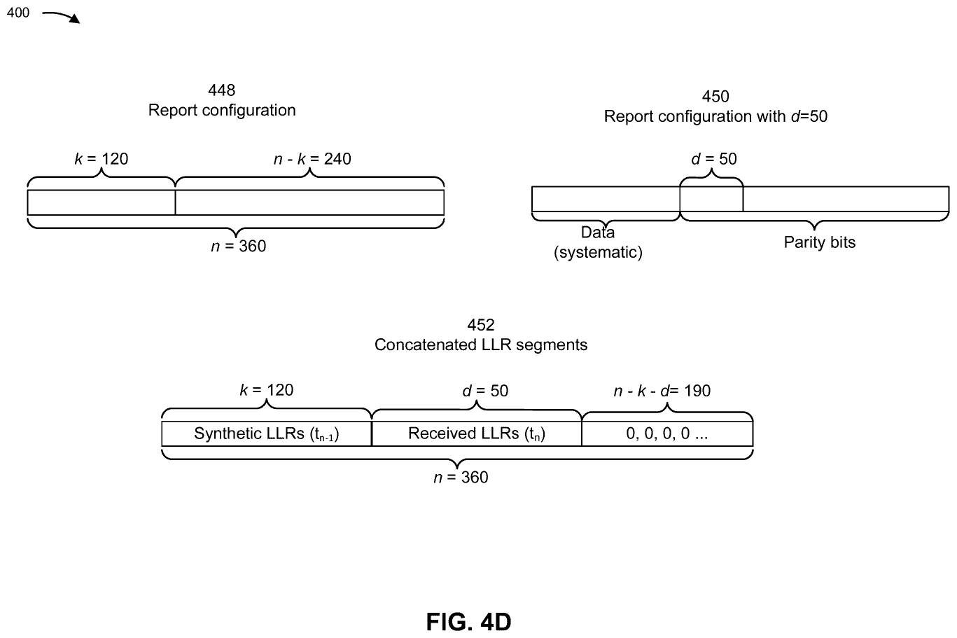

FIGS. 4A-4D are diagrams illustrating an example 400 associated with FDRSB mitigation. As shown in FIGS. 4A-4D, a network node (e.g., network node 110) and one or more UEs (e.g., UE 120) may communicate with one another.

As shown in FIG. 4A, and by reference number 402, the network node may transmit, and the UE may receive, a request for a plurality of FDRSB reports. In some aspects, the request may include a pilot signal, which may be a dedicated pilot signal or a pilot signal associated with a PHY layer (e.g., associated with DMRS, CSI-RS, or the like). In some aspects, the pilot signal may be transmitted to a plurality of UEs. Additionally, or alternatively, the pilot signal may be transmitted in a transmission, to the UE, that is separate from the request. In some aspects, the pilot signal may be unique to each UE of a plurality of UEs to which the pilot signal is transmitted.

Alternatively, in some aspects, the pilot signal may be transmitted as a broadcast signal in which the pilot signal is common for the plurality of UEs (e.g., each UE of the plurality of UEs receives the same pilot signal).

As shown by reference number 404, the UE may transmit, and the network node may receive, a first report. In some aspects, the first report may include a full FDRSB model associated with a first FDRSB estimation (e.g., the FDRSB may include the full first FDRSB estimation). In some aspects, the first FDRSB estimation may be associated with an estimation of FDRSB impairment associated with the received pilot signal. For example, the FDRSB estimation may be associated with an estimation of FDRSB impairment associated with one or more antennas associated with the transmitter (e.g., one or more transmission chains). In some aspects, the network node may receive a first report from each UE of the plurality of UEs that received a pilot signal from the network node and that is capable of FDRSB estimation. Additionally, in some aspects, the full FDRSB model may be associated with the full (e.g., complete) FDRSB estimation.

As shown by reference number 406, the network node may decode the first report in order to obtain the full FDRSB model associated with the first FDRSB estimation. In some aspects, the network node may apply FDRSB correction based at least in part on the full FDRSB model received in the first report from the UE. Additionally, or alternatively, the network node may apply FDRSB correction based at least in part on the full FDRSB model received in the first report from each respective UE of the plurality of UEs that transmitted a first report based on a pilot signal from the network node.

As shown by reference number 408, the UE may transmit, and the network node may receive, a second report. In some aspects, the second report may include a partial FDRSB model associated with a second FDRSB estimation. In some aspects, the second FDRSB estimation may be associated with an estimation of FDRSB impairment associated with a signal (e.g., a pilot signal) received, at the UE, subsequent to the UE transmitting the first report. For example, the FDRSB estimation may be associated with an estimation of FDRSB impairment associated with one or more antennas associated with the transmitter (e.g., one or more transmission chains). In some aspects, the network node may receive a second report from each UE of the plurality of UEs that received a signal subsequent to the respective UE transmitting the first report.

In some aspects, the second FDRSB estimation may be compressed to generate the partial FDRSB model. In some aspects, the second FDRSB estimation may be compressed according to a distributed coding framework, as described herein. For example, because FDRSB impairment varies over time, the second FDRSB estimation may be compressed based on a correlation of FDRSB impairment between the first FDRSB estimation and the second FDRSB estimation. In some aspects, the second FDRSB model may function as an update to the first FDRSB model, and the second FDRSB model may include a punctured representation of the second FDRSB estimation.

For example, FDRSB impairment levels may vary as a function of time in addition to varying as a function of frequency. Additionally, where there is a change in temperature (e.g., over a time period) in a network environment, FDRSB impairment levels may change as a function of temperature. As a result, the second FDRSB may be punctured according to a puncturing configuration (e.g., provided by the network node) that provides puncturing parameters that may be based on one or more correlations between the second FDRSB estimation and the first FDRSB estimation.

As shown by reference number 410, the network node may decode the second report in order to obtain the second FDRSB model associated with the second FDRSB estimation. For example, the network node may reconstruct the full FDRSB estimation from the partial FDRSB model (e.g., depuncture the partial FDRSB model). In some aspects, the network node may apply FDRSB correction based at least in part on the partial FDRSB model received in the second report from the UE. Additionally, or alternatively, the network node may apply FDRSB correction based at least in part on the partial FDRSB model (e.g., based on the reconstructed second FDRSB estimation) received in the second report from each respective UE of the plurality of UEs that received a pilot signal subsequent to the respective UE transmitting the first report.

As shown in FIG. 4B, and by reference number 412, a network node may transmit, and a first UE (designated as “UE1”) may receive, a request for an indication of FDRSB estimation capability associated with the first UE. Additionally, and as shown by reference number 414, the network node may transmit, and a second UE (designated as “UE2”) may receive, a request for an indication of FDRSB estimation capability associated with the second UE. For example, the network node may transmit the request for an indication of FDRSB estimation capability via a MAC-CE transmission or an RLC transmission, among other examples.

As shown by reference number 416, the first UE may transmit, and the network node may receive, an indication indicating that the first UE is capable of FDRSB estimation. As shown by reference number 418, the second UE may transmit, and the network node may receive, an indication indicating that the second UE is incapable of FDRSB estimation. For example, the second UE may lack hardware components or one or more configurations associated with FDRSB estimation, or the second UE may otherwise be unable to perform FDRSB estimation.

As shown by reference number 420, the network node may transmit, and the first UE may receive, a request for a plurality of FDRSB reports, as described herein. In some aspects, the request may include a pilot signal, which may be a dedicated pilot signal or a pilot signal associated with a PHY layer (e.g., associated with DMRS, CSI-RS, or the like). In some aspects, the pilot signal may be transmitted to a plurality of UEs. Additionally, or alternatively, the pilot signal may be transmitted in a transmission that is separate from the request. In some aspects, the pilot signal may be unique to each UE of a plurality of UEs to which the pilot signal is transmitted. Alternatively, in some aspects, the pilot signal may be transmitted as a broadcast signal in which the pilot signal is common for the plurality of UEs (e.g., each UE of the plurality of UEs receives the same pilot signal).

As shown by reference number 422, the first UE may transmit, and the network node may receive, a first report, as described herein. In some aspects, the first report may include a full FDRSB model associated with a first FDRSB estimation (e.g., the FDRSB may include the full first FDRSB estimation). In some aspects the first FDRSB estimation may be associated with an estimation of FDRSB impairment associated with the received pilot signal. For example, the FDRSB estimation may be associated with an estimation of FDRSB impairment associated with one or more antennas associated with the transmitter (e.g., one or more transmission chains). In some aspects, the network node may receive a first report from each UE of the plurality of UEs that indicated that the respective UE was capable of FDRSB estimation and that received a pilot signal from the network node. Additionally, in some aspects, the full FDRSB model may be associated with the full (e.g., complete) FDRSB estimation.

As shown by reference number 424, the network node may decode the first report in order to obtain the full FDRSB model associated with the first FDRSB estimation, as described herein. In some aspects, the network node may apply FDRSB correction based at least in part on the full FDRSB model received in the first report from the first UE. Additionally, or alternatively, the network node may apply FDRSB correction based at least in part on the full FDRSB model received in the first report from each respective UE of the plurality of UEs that transmitted a first report based on a pilot signal from the network node.

As shown by reference number 426, the first UE may transmit, and the network node may receive, a second report. In some aspects, the second report may include a partial FDRSB model associated with a second FDRSB estimation. In some aspects the second FDRSB estimation may be associated with an estimation of FDRSB impairment associated with a signal (e.g., a pilot signal) received, at the first UE, subsequent to the first UE transmitting the first report. For example, the FDRSB estimation may be associated with an estimation of FDRSB impairment associated with one or more antennas associated with the transmitter (e.g., one or more transmission chains). In some aspects, the network node may receive a second report from each UE of the plurality of UEs that received a signal received subsequent to the respective UE transmitting the first report.

In some aspects, the second FDRSB estimation may be compressed to generate the partial FDRSB model. In some aspects, the second FDRSB estimation may be compressed according to a distributed coding framework, as described herein. For example, because FDRSB impairment varies over time, the second FDRSB estimation may be compressed according to a correlation of FDRSB impairment between the first FDRSB estimation and the second FDRSB estimation. In some aspects, the second FDRSB model may function as an update to the first FDRSB model, and the second FDRSB model may include a punctured representation of the second FDRSB estimation.

For example, once the initial FDRSB estimation is obtained, it may be encoded using a specific coding scheme such as LDPC coding. The encoded estimation may then be punctured according to a puncturing configuration received from the network node. The puncturing configuration may include parameters such as the number of parity bits and the positions of the parity bits within the encoded sequence. This configuration may be utilized to generate a partial FDRSB model by selectively removing certain bits from the encoded sequence, thereby reducing the data size for transmission.

As shown by reference number 428, the network node may decode the second report in order to obtain the second FDRSB model associated with the second FDRSB estimation. For example, the network node may reconstruct the full FDRSB estimation from the partial FDRSB model (e.g., depuncture the partial FDRSB model). In some aspects, the network node may apply FDRSB correction based at least in part on the partial FDRSB model received in the second report from the first UE. Additionally, or alternatively, the network node may apply FDRSB correction based at least in part on the partial FDRSB model (e.g., based on the reconstructed second FDRSB estimation) received in the second report from each respective UE of the plurality of UEs that received a pilot signal subsequent to the respective UE transmitting the first report.

As shown in FIG. 4C, and by reference number 430, a network node may transmit, and a UE may receive, a request for a plurality of FDRSB reports. In some aspects, the UE may have previously indicated, to the network node, that the UE is capable of FDRSB estimation. In some aspects, the request may specifically request a full FDRSB model associated with the UE's FDRSB estimation.

In some aspects, the request may include a pilot signal, which may be a dedicated pilot signal or a pilot signal associated with a PHY layer (e.g., associated with DMRS, CSI-RS, or the like). In some aspects, the pilot signal may be transmitted to a plurality of UEs. Additionally, or alternatively, the pilot signal may be transmitted in a transmission, to each UE, that is separate from the request. In some aspects, the pilot signal may be unique to each UE of a plurality of UEs to which the pilot signal is transmitted. Alternatively, in some aspects, the pilot signal may be transmitted as a broadcast signal in which the pilot signal is common for the plurality of UEs (e.g., each UE of the plurality of UEs receives the same pilot signal).

In some aspects, the request may include a scheduling configuration that indicates a scheduling of one or more reports (e.g., a first report, a second report, and so on) to be transmitted to the network node, from the UE. For example, the scheduling configuration may inform each UE, of the plurality of UEs, of the network node's FDRSB for estimation, a granularity associated with FDRSB estimation, or a frequency region for estimation, among other examples. Additionally, the request may include an FDRSB impairment model associated with FDRSB estimation at the UE. Similarly, the network node may indicate (e.g., via the request) the FDRSB impairment model to each UE of the plurality of UEs that receive the request, thereby enabling each UE to estimate and report FDRSB impairment information using the same FDRSB impairment model.

As shown by reference number 432, the UE may transmit, and the network node may receive, a first report. In some aspects, the first report may include a full FDRSB model associated with a first FDRSB estimation. In some aspects the first FDRSB estimation may be associated with an estimation of FDRSB impairment associated with the received pilot signal. For example, the FDRSB estimation may be associated with an estimation of FDRSB impairment associated with one or more antennas associated with the transmitter (e.g., one or more transmission chains). In some aspects, the network node may receive a first report from each UE of the plurality of UEs that received a pilot signal from the network node and that are capable of FDRSB estimation. Additionally, in some aspects, the full FDRSB model may be associated with the full (e.g., complete) FDRSB estimation.

In some aspects, the full FDRSB model includes one or more coefficient values associated with the first FDRSB estimation, and the coefficient values may be selected for the full FDRSB model based at least in part on an estimation granularity configuration. For example, where an estimation granularity (e.g., a frequency-dependent granularity) is indicated as 4 RBs of allocated bandwidth to estimate 20 RBs, and the UE is to estimate FDRSB associated with 3 transmission antennas, the report may include 5 coefficient values per antenna (e.g., 20 RBs/4 RBs). As a result, the first report may include 15 coefficients (e.g., 5 coefficient values per antenna×3 antennas).

In some aspects, the coefficients (e.g., information) in the report may be encoded using a relatively low coding rate and a relatively low operated modulation order in order to improve the decoding accuracy (e.g., to ensure a relatively high level of accuracy). For example, because the reconstruction of the partial FDRSB model (e.g., associated with the punctured FDRSB estimation included in the second report) may be based on the full FDRSB model (e.g., included in the first report), an accurately decoded full FDRSB model will increase the probability that the partial FDRSB model is accurately decoded and accurately represents the second FDRSB estimation.

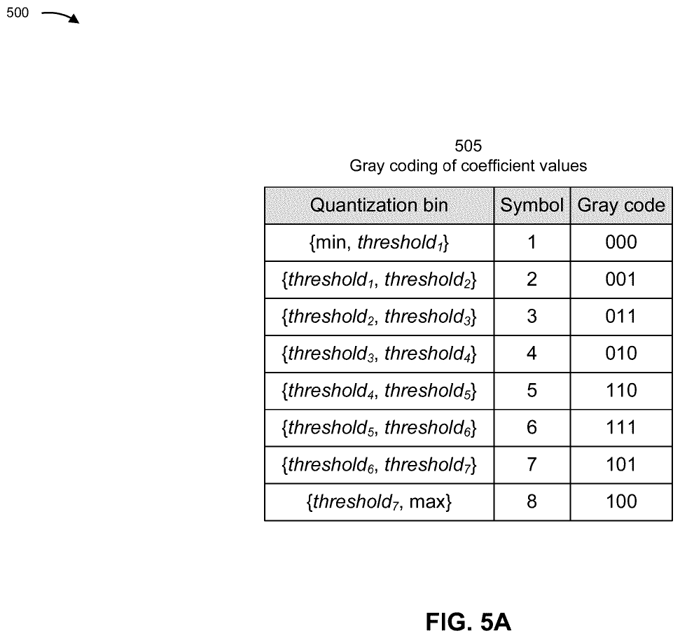

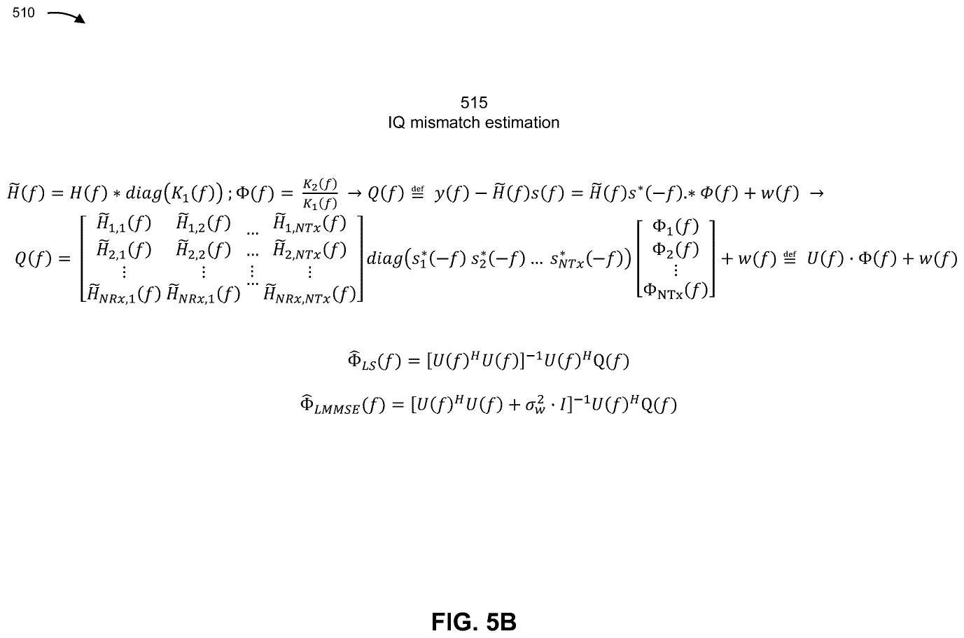

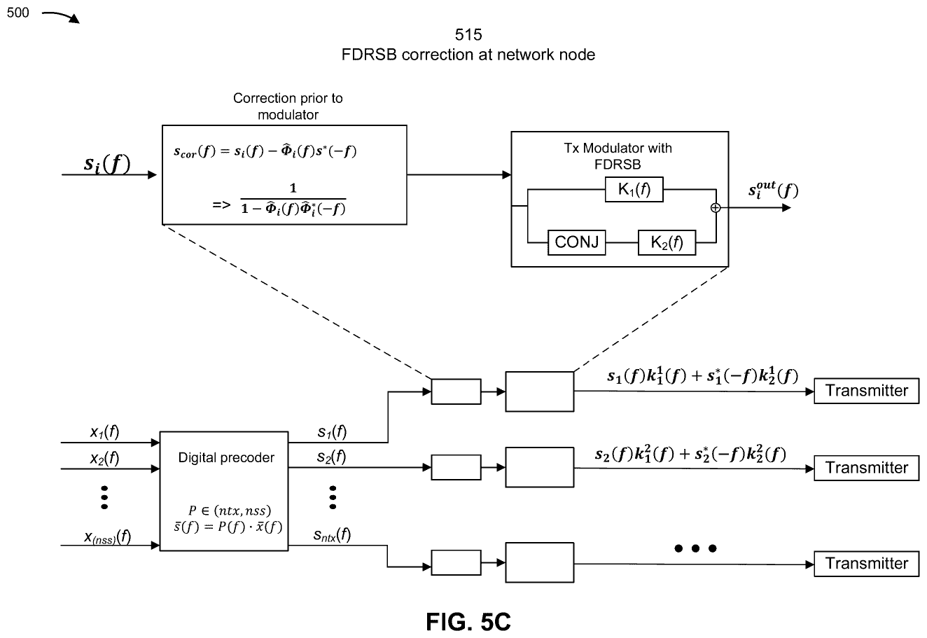

In some aspects, the UE may perform FDRSB estimation according to an estimation configuration received from the network node, or otherwise obtained by the UE. In some aspects, where the network node has requested FDRSB reports from a plurality of UEs, each UE may utilize the same FDRSB estimation procedure or the UEs may utilize different FDRSB estimation procedures. For example, one or more of the UEs may perform an IQ mismatch estimation (e.g., an FDRSB estimation), as described below with respect to FIG. 5B. In some aspects, the initial estimation may be referred to as φᵢ(f)ₜ₌ₜ_{₀}, where t₀ is associated with the first FDRSB estimation.

As shown by reference number 434, the network node may decode the first report in order to obtain the full FDRSB model associated with the first FDRSB estimation. In some aspects, the network node may apply FDRSB correction based at least in part on the full FDRSB model received in the first report from the UE. Additionally, or alternatively, the network node may apply FDRSB correction based at least in part on the full FDRSB model received in the first report from each respective UE of the plurality of UEs that transmitted a first report based on a pilot signal from the network node.

As shown by reference number 436, the network node may transmit, and the UE may receive, a transmission on which the UE may perform FDRSB estimation (e.g., the second FDRSB estimation). In some aspects, the network node may use the decoded FDRSB model values (e.g., associated with the full FDRSB model received in the first report) to apply the inverse model on the transmission to the UE, as described herein.

As shown by reference number 438, the UE may transmit, and the network node may receive, a second report. In some aspects, the second report may include a partial (e.g., compressed) FDRSB model associated with a second FDRSB estimation. For example, the UE may perform a full FDRSB estimation according to an impairment model received from the network node, but the UE will transmit, to the network node, a compressed version of the second FDRSB estimation

$$( {{ϕ}_{i}^{d} ( f )}_{t = {t}_{1}} ) .$$

For example, the second estimation may be represented by φᵢ(f)ₜ₌ₜ_{₁}, where t₁ is associated with the second FDRSB estimation. Similarly, the first estimation may be represented by φᵢ(f)ₜ₌ₜ_{₀}, where t₀ is associated with the first FDRSB estimation.

In some aspects the second FDRSB estimation may be associated with an estimation of FDRSB impairment associated with a signal (e.g., a pilot signal) received, at the UE, subsequent to the UE transmitting the first report. For example, the FDRSB estimation may be associated with an estimation of FDRSB impairment associated with one or more antennas associated with the transmitter (e.g., one or more transmission chains). In some aspects, the network node may receive a second report from each UE of the plurality of UEs that received a signal received subsequent to the respective UE transmitting the first report.

In some aspects, the UE may encode the estimated values (e.g., coefficient values) using the same form as the estimated values transmitted in the first report. In some aspects, the network node may indicate a change in a code rate across different slots according to conservativity considerations and cell or network environment. For example, the network node may transmit an indication of one or more new code rates, and the UE may utilize the new code rates during encoding.

In some aspects, the second FDRSB estimation may be compressed to generate the partial FDRSB model. In some aspects, the second FDRSB estimation may be compressed according to a distributed coding framework, as described herein. For example, because FDRSB impairment varies over time, the second FDRSB estimation may be compressed according to a correlation of FDRSB impairment between the first FDRSB estimation and the second FDRSB estimation. In some aspects, the second FDRSB model may function as an update to the first FDRSB model, and the second FDRSB model may include a punctured representation of the second FDRSB estimation.

In some aspects, after encoding the second FDRSB estimation (e.g., the estimated values), the UE may determine which segments of the second FDRSB estimate will be transmitted in the second report. Because of a correlation of the data (e.g., systematic) portion of the second FDRSB model and the data portion of the first FDRSB model, sending only a part of the data portion of the second FDRSB estimation may cause a relatively small increase in the entropy (e.g., information) transmitted. For example, the correlation may be dependent on the length of a time period between the first FDRSB estimation and the second FDRSB estimation. In contrast, the parity bits of the second FDRSB estimation may have a relatively lower correlation with the first FDRSB estimation. For example, the first portion of the parity bits may include a higher entropy relative to the remaining portion of the parity bits (e.g., where the code is configured to accommodate a higher weight on the first parity bits, and the first parity bits are connected to a relatively large quantity of other bits in a bi-partite graph).

Accordingly, in some aspects, the partial FDRSB report may include bits associated with entropy levels that satisfy (e.g., exceed) a threshold when compared to the bits of the previous report. For example, because the first portion of the parity bits may include a higher relative entropy, the partial FDRSB report may include a set of parity bits that begins at the first parity bit.

In some aspects, the partial segment of the second FDRSB estimation, or a subsequent FDRSB estimation, may be denoted by a segment length of d bits of the full FDRSB estimation. In other words, the compressed FDRSB estimation (e.g., the partial FDRSB model) may include only a segment length of d bits (e.g., parity bits) in the associated report. In some aspects, the segment length d may be determined according to a configuration received from the network node. In some aspects, the network node may indicate a value of the segment length d via UCI message, among other examples.

In some aspects, the network node may consider an FDRSB autocorrelation of each FDRSB coefficient included in each respective FDRSB model. For example, during a training period, the network node may request that the UE (or each UE of the plurality of FDRSB-estimation-capable UEs) provide a full FDRSB model for a certain quantity of successive reports, thereby enabling the network node to learn the autocorrelation parameters. Similarly, the network node may learn one or more autocorrelation parameters during an “offline learning” session before the network node is deployed. For example, such a training period may enable the network node to understand the correlations and variations over time, which can be used to optimize future estimations and corrections.

Additionally, or alternatively, the network node may configure the segment length d based on the length of a time period measured since receiving the first report. Similarly, in some aspects, the network node may configure the segment length d based on the length of a time period measured since receiving the preceding report (e.g., where the preceding report is the second report, the third report, and so on). For example, where a relatively small amount of time has passed since the preceding report (e.g., below a configured threshold), the network node may assign a lower value to d because there is a relatively higher probability of high correlation between the preceding report and the next report, due to the FDRSB impairment generally changing as a function of time. Similarly, if a relatively large amount of time has passed since the preceding report (e.g., above a configured threshold), the network node may assign a higher value to d because there is a relatively lower probability of high correlation between the preceding report and the next report, due to the FDRSB impairment generally changing as a function of time.

Additionally, or alternatively, the network node may consider the reliability of bits that were decoded in the first (or the preceding) report. For example, in the case of decoded bits being associated with a relatively high log-likehood ratio (LLR), the network node may assign a higher value to d because of a relatively high reliability. In contrast, in the case of decoded bits being associated with a relatively low LLR, the network node may configure a lower value to d because of a relatively low reliability. Additionally, in some aspects, the network node may configure a periodicity in which each UE transmits one or more reports to the network node. For example, where one or more received reports are associated with relatively low reliability levels (e.g., a low LLR value, a low correlation, or the like), the network node decrease the time period between each UE's transmission of successive reports (e.g., increase the frequency of transmitted reports from one or more UEs).

Additionally, or alternatively, the network node may consider a temperature change during the time period since receipt of the first (e.g., the preceding) report. For example, if the temperature change or the absolute temperature satisfies (e.g., exceeds) a threshold, the network node may configure a higher value to d. In contrast, if the temperature change or the absolute temperature fails to satisfy (e.g., is below) a threshold, the network node may retain a previous value of d, or the network node may configure a relatively lower value to d.

In some aspects the network node may request that additional bits be included in the second report (or a subsequent report) in order to increase the reliability or certainty of the FDRSB estimation associated with the second FDRSB model (or a subsequent FDRSB model). Additionally, the network node may request that a full FDRSB model (e.g., in contrast to a partial FDRSB model) be included in the second report (or a subsequent report). For example, where the network node determines that the correlation between a current report (e.g., a second report) and a previous report (e.g., a first report) fails to satisfy a threshold, the network node may request that the UE transmit a full FDRSB model in the next report (e.g., a third report). Similarly, for example, where the time period between receipt of the current report and receipt of the previous report satisfies (e.g., exceeds) a threshold, the network node may request that the UE transmit a full FDRSB model in the next report. Similarly, for example, where a difference between the measured temperature associated with the current report and the measured temperature associated with the previous report satisfies (e.g., exceeds) a threshold, the network node may request that the UE transmit a full FDRSB model in the next report.

Additionally, for example, the UE may report φᵢ(f)ₜ₌ₜ_{₀}, which may have a correlation with φᵢ(f)ₜ₌ₜ_{₁}, and may be depicted as:

$$H ( {{ϕ}_{i} ( f )}_{t = {t}_{1}} ) = H ( {{ϕ}_{i} ( f )}_{t = {t}_{0}} ) + H ( {{ϕ}_{i} ( f )}_{t = {t}_{1}} \vert {{ϕ}_{i} ( f )}_{t = {t}_{0}} ) ,$$

where H(⋅) may denote an entropy operator (e.g., information). The estimation of FDRSB impairment according to a successive signal received at a receiver (e.g., a UE), H(f) may denote a channel, s(f)k₁(f) may denote a desired transmitter output, s*(−f)k₂(f), and w(f) may denote noise.

For example, the UE may report φᵢ(f)ₜ₌ₜ_{₀}, which may have a correlation with φᵢ(f)ₜ₌ₜ_{₁}, and may be depicted as:

$$( {{ϕ}_{i} ( f )}_{t = {t}_{1}} ) = H ( {{ϕ}_{i} ( f )}_{t = {t}_{0}} ) + H ( {{ϕ}_{i} ( f )}_{t = {t}_{1}} \vert {{ϕ}_{i} ( f )}_{t = {t}_{0}} ) ,$$

where H(⋅) may denote an entropy operator (e.g., information).

The estimation of FDRSB impairment according to successive estimations (e.g., the first FDRSB estimation and the second FDRSB estimation) may be depicted as:

$$H ( {{ϕ}_{i} ( f )}_{t = 1} ) \geq H ( {{ϕ}_{i} ( f )}_{t = {t}_{1}} \vert {{ϕ}_{i} ( f )}_{t = {t}_{0}} ) ,$$

and accordingly, for H(φᵢ(f)ₜ₌ₜ_{₁}), it may be sufficient for the network node to receive less information (H(φᵢ(f)ₜ₌ₜ_{₁}|φᵢ(f)ₜ₌ₜ_{₀})) in the second report (e.g., in each successive report) because the network node has already decoded H(φᵢ(f)ₜ₌ₜ_{₀}), and there is a correlation between the FDRSB model coefficient at t₀ and t₁. As a result, each successive (e.g., subsequent) report may include partial information (e.g., decreasing information relative to the previous report), thereby lowering transmission overhead and conserving network and processing resources.

As shown by reference number 440, the network node may decode the second report and perform FDRSB correction, based on the FDRSB model associated with the second report. For example, after receiving the second report (e.g., including the partial FDRSB model), that includes a first portion of parity bits (e.g., a segment associated with the value represented by “d”), the network node may reconstruct (e.g., decode) the full FDRSB model (e.g., the full second FDRSB estimation). In some aspects, the network node may decode the second report and refine the FDRSB corrections applied to the transmitted signals. For example, upon receiving the partial FDRSB model, the network node may update its correction algorithm to address new impairments. Additionally, or alternatively, the network node may process the second report and adjust the signal parameters accordingly to maintain low side band interference. For example, using the decoded partial FDRSB model, the network node may perform additional signal corrections to ensure optimal performance.

For example, the network node may receive the partial FDRSB model and reconstruct the full FDRSB estimation by decoding the received bits. The decoding process may involve concatenating the received LLR segments with synthetic LLRs generated from previously decoded data. The decoding algorithm may then be applied to reconstruct the original FDRSB estimation.

In some aspects, the network node may concatenate three different LLR segments associated with the second report in order to generate an input to a decoding element associated with the network node. For example, the concatenated LLR segments may include one or more synthetic LLRs (e.g., representing the former decoded data from the previous report), the calculated LLRs of the current report (e.g., the first portion of parity bits, including the segment associated with the value d), and a set of zeroed LLRs (e.g., due to a lack of information associated with the remainder of the parity bits, the LLRs are set to 0, which represents an equal probability of 0 or 1).

In some aspects, the network node may determine the manner in which the synthetic LLRs are calculated and positioned in the beginning of the associated report (e.g., the second report). In some aspects, the network node may determine the sign of each LLR according to a decoded bit associated with decoding of the previous report (e.g., tₙ−1). For example, a negative value for a bit that was previously decoded as a “1” and a positive value for a bit that was previously decoded as a “0”.

In some aspects, the LLR magnitude may be relatively high for a bit that represents a most significant bit (MSB) of an FDRSB coefficient, due to a relatively low probability that the bit has changed. In contrast to the MSB, for example, an LLR that represents a least significant bit (LSB) of a coefficient may be synthetically reconstructed utilizing a relatively low magnitude value. In some aspects, the network node may consider a history of the change in value associated with the bit. For example, bits that change with a high rate or a low rate (e.g., according to the most recent report) may be associated with a large magnitude or a small magnitude, respectively. Additionally, the network node may also consider the rate of change associated with the model parameters that were chosen by the network node. Additionally, or alternatively, network node may decide the magnitude associated with each LLR according to a policy associated with the network node or according to a conservativity configuration associated with the network node. As a result, the described techniques may increase the accuracy of decoding the compressed FDRSB reports while conserving transmission resources

In some aspects, after concatenation of the LLRs, the concatenated LLRs may serve as an input to a decoder (e.g., an LDPC decoder). For example, according to the distributed coding configuration and the network node's configuration of the value associated with d, the network node may decode the bits associated with the current report (e.g., the second report). Furthermore, the results of decoding the current report (e.g., the second report) may be utilized as the synthetic portion for decoding of the next received report (e.g., the third report).

In some aspects, where detection of the current report (e.g., the second report) has failed (e.g., due to a cyclic redundancy code (CRC) error), the network node may ignore the current report and utilize the last properly-decoded FDRSB model. For example, where the network node is unable to successfully decode an nth report, the network node may ignore the nth report, and instead, the network node may utilize the (n−1)th report (e.g., where the (n−1)th report was properly decoded).

Additionally, or alternatively, the network node may increase the value of d at the next request for FDRSB reports, or the network node may request a full FDRSB model at the next request (e.g., a non-compressed, full FDRSB model that includes a full systematic bits portion and a full parity bits portion), in order to establish a new FDRSB estimation that may be utilized as a reference in future transmissions. As a result, the network node may maintain accurate FDRSB estimations despite occasional decoding failures.

In some aspects, the decoding of the second report may be utilized to train the network node as to the FDRSB impairment present in the network by utilizing a correlation between the first FDRSB estimation and the second FDRSB estimation. Similarly, for example, in subsequent reports (e.g., a third report, a fourth report, and so on) received from the UE, the network node may utilize a correlation between a current FDRSB estimation (e.g., a fourth FDRSB estimation included in a fourth report) and a preceding FDRSB estimation (e.g., a third FDRSB estimation associated with a third report). As a result of utilizing the correlation of reports from different times, the network may improve spectral efficiency, and the components of the wireless network may reduce power consumption and transmission overhead.

As shown by reference number 442, the network node may transmit, and the UE may receive, a transmission on which the UE may perform FDRSB estimation (e.g., the nth FDRSB estimation). In some aspects, the network node may use the decoded FDRSB model values (e.g., associated with the full FDRSB model received in the first report or the partial FDRSB model received in the (n−1)th report) to apply the inverse model on the transmission to the UE, as described herein.

As shown by reference number 444, the UE may transmit, and the network node may receive, an nth report. In some aspects, the nth report may include a partial (e.g., compressed) FDRSB model associated with an nth FDRSB estimation. For example, the UE may perform a full FDRSB estimation according to an impairment model received from the network node, but the UE will transmit, to the network node, a compressed version of the nth FDRSB estimation

$$( {{ϕ}_{i}^{d} ( f )}_{t = {t}_{n}} ) .$$

For example, the nth estimation may be represented by φᵢ(f)ₜ₌ₜ_{ₙ}, where tₙ is associated with the nth FDRSB estimation.

As shown by reference number 446, the network node may decode the nth report and perform FDRSB correction, based on the FDRSB model associated with the nth report, as described herein. For example, after receiving the nth report (e.g., including a partial FDRSB model), that includes a first portion of parity bits (e.g., a segment associated with the value represented by “d”), the network node may reconstruct (e.g., decode) the full FDRSB model (e.g., the full nth FDRSB estimation). In some aspects, the network node may decode the nth report and refine the FDRSB corrections applied to the transmitted signals. For example, upon receiving the partial FDRSB model, the network node may update its correction algorithm to address new impairments. Additionally, or alternatively, the network node may process the nth report and adjust the signal parameters accordingly to maintain low side band interference. For example, using the decoded partial FDRSB model, the network node may perform additional signal corrections to ensure optimal performance.

As shown in FIG. 4D, and by reference number 448, for example, where the network node estimation granularity (e.g., a frequency-dependent granularity) is indicated as 4 RBs of allocated bandwidth to estimate of 20 RBs, and the UE is to estimate FDRSB associated with 3 transmission antennas, the report may include 5 coefficient values per antenna (e.g., 20 RBs/4 RBs). As a result, the associated report may include 15 coefficients (e.g., 5 coefficient values per antenna×3 antennas). Additionally, where each coefficient may be represented by 8 bits, and the operated MCS is quadrature phase shift keying (QPSK) with a rate of 1/3, the initial transmission may consist of 8 bits per coefficient. Based on 15 coefficients in the associated report, the report may include 120 uncoded bits, k, (e.g., 8 bits per coefficient×15 coefficients) and 360 coded bits, n, (e.g., including 240 parity bits), and may utilize 180 resource elements (REs) (e.g., 2 bits in each RE when utilizing QPSK).

As shown by reference number 450, for example, the network node may assign a value of 50 bits to d. For example, because only the first 50 bits (e.g., associated with d) are transmitted, this may result in an overhead savings of approximately 86% for subsequent transmissions

$$( e . g . , ( 1 - \frac{50}{360} ) \times 100 \% = 86 \% ) .$$

As shown by reference number 452, for example, the network node may decode a report by concatenating three different LLR segments as an input to a decoder, as described herein. For example, the concatenated LLR segments may include one or more synthetic LLRs (e.g., representing the former decoded data from the previous report), the calculated LLRs of the current report (e.g., the first portion of parity bits, including the segment associated with the value d), and a set of zeroed LLRs (e.g., due to a lack of information associated with the remainder of the parity bits, the LLRs are set to 0, which represents an equal probability of 0 or 1).

In some aspects, the network node may determine the manner in which the synthetic LLRs are calculated and positioned in the beginning of the associated report (e.g., the second report). In some aspects, the network node may determine the sign of each LLR according to a decoded bit associated with decoding of the previous report (e.g., tₙ−1). For example, a negative value for a bit that was previously decoded as a “1” and a positive value for a bit that was previously decoded as a “0”.

As described herein, some example techniques may be utilized for federated collaboration between a UE and one or more UEs to digitally estimate FDRSB impairment according to one or more pilot signals associated with all or a portion of transmitter chains associated with the network node, via a distributed coding approach. Additionally, the one or more UEs may transmit, to the network node, FDRSB models (e.g., including FDRSB estimation associated with FDRSB impairment for one or more transmitter chains), and the network node may utilize the FDRSB models for digital correction of the FDRSB impairment. Each UE of the one or more UEs may transmit a plurality of reports (e.g., a second report, a third report, a fourth report, and so on), and each additional report may include an updated partial FDRSB model associated with additional FDRSB estimation. Additionally, the network node may perform further FDRSB correction based on each of the additional reports. Furthermore, one or more UEs, of the set of UEs, may transmit, to the network node, a capability report indicating an FDRSB estimation capability associated with the respective UE.

As a result, the described techniques can be used to reduce the processing overhead and power consumption at one or more UEs and at a network node by dividing FDRSB estimation and FDRSB correction between the one or more UEs and the network node, respectively. For example, by performing FDRSB correction based on FDRSB estimation reports received from the one or more UEs, the network node may avoid performing FDRSB estimation, thereby reducing processing overhead and power consumption. Additionally, dividing FDRSB estimation across a plurality of UEs may reduce the power consumption associated with FDRSB estimation at each UE of the plurality of UEs. Similarly, where FDRSB estimation is performed by multiple UEs, each UE may experience an increase in processing gain or an increase in the quantity of supported estimation parameters, relative to FDRSB estimation being performed at a single UE, thereby resulting in increased FDRSB estimation accuracy.

Furthermore, performing FDRSB correction at the network node (e.g., as opposed to at the UEs performing FDRSB estimation) allows all UEs served by the network node to benefit from FDRSB correction. For example, UEs that are not capable of FDRSB estimation (e.g., UEs that did not transmit FDRSB estimation reports to the network node) may benefit from the FDRSB correction performed at the network node. Additionally, in some examples, the network node and the UE may collaboratively perform FDRSB estimation and correction without the network node or the UE dedicating existing or additional hardware components to performing both FDRSB estimation and FDRSB correction.

As indicated above, FIGS. 4A-4D are provided as examples. Other examples may differ from what is described with respect to FIGS. 4A-4D.

FIGS. 5A-5C are diagrams illustrating example 500 and 510 associated with FDRSB mitigation.

As shown in FIG. 5A, and by reference number 505, the coefficient values associated with an FDRSB report may be quantized with Gray coding, which may ensure that small Euclidean variations (e.g., due to additive white Gaussian noise (AWGN)) of an associated analog representing symbol may result in a small number of bit alterations. For example, and as illustrated in FIG. 5A, symbol values may be encoded with three bits according to a Gray coding table.

As shown in FIG. 5B, and by reference number 515, in some aspects, the UE may perform FDRSB estimation according to an estimation configuration received from the network node or otherwise obtained by the UE. In some aspects, where the network node has requested FDRSB reports from a plurality of UEs, each UE may utilize the same FDRSB estimation procedure or may utilize different FDRSB estimation procedures. For example, one or more of the UEs may perform an IQ mismatch estimation (e.g., an FDRSB estimation) expressed as reference number 515, where y(f) may denote a signal received at a receiver (e.g., a UE), H(f) may denote a channel, s(f)k₁(f) may denote a desired transmitter output, s*(−f)k₂(f), and w(f) may denote noise. In some aspects, after completing FDRSB estimation, the UE (e.g., or one or more additional UEs for which the network node has requested FDRSB reporting) may transmit estimation of FDRSB, \hat{φ}(f), for all transmission antennas for which the network node has requested estimation.

As shown in FIG. 5C, and by reference number 515, the network node may perform FDRSB mitigation. In some aspects, the network node may receive the \hat{φ}(f) from each UE that has transmitted a report, and the network node may calculate an average value associated with the \hat{φ}(f) values. Additionally, or alternatively, where channel conditions are different at each UE, the network node may utilize a weighted average (e.g., each UE's report may also include a quality metric, such as signal-to-noise ratio (SNR)). In some aspects, the FDRSB correction may be performed before an IQ modulator and after a precoder.

In some aspects, where \hat{φ}(f)=φᵢ(f), then

$${s}_{i} ( f ) = {s}_{i}^{out} ( f ) ,$$

as expressed by

$$\begin{matrix}{s}^{o u t} ( f ) = \frac{1}{1 - Φ ( f ) Φ ⋆ ( - f )} ( {s}_{c o r} ( f ) + Φ ( f ) {s}_{c o r}^{*} ( - f ) ) \\ = \begin{matrix}\frac{1}{1 - Φ ( f ) Φ ⋆ ( - f )} ( ( s ( f ) - Φ ( f ) {s}^{*} ( - f ) ) + \\ Φ ( f ) ( {s}^{*} ( - f ) - Φ ⋆ ( - f ) s ( f ) ) )\end{matrix} \\ = \frac{1}{1 - Φ ( f ) Φ ⋆ ( - f )} s ( f ) * ( 1 - Φ ( f ) Φ ⋆ ( - f ) ) = s ( f )\end{matrix}$$

In some aspects, the output of the transmitter modulator may be expressed as

$$s ( f ) {=}^{Δ} {[ {s}_{1} ( f ) {s}_{2} ( f ) … {s}_{ntx} ( f ) ]}^{T}$$

$${k}_{1} ( f ) {=}^{Δ} {[ {k}_{1}^{1} ( f ) {k}_{1}^{2} ( f ) … {k}_{1}^{ntx} ( f ) ]}^{T}$$

$${k}_{2} ( f ) {=}^{Δ} {[ {k}_{2}^{1} ( f ) {k}_{2}^{2} ( f ) … {k}_{2}^{ntx} ( f ) ]}^{T}$$

In some aspects, neglecting the additive noise term, the observed signal with the FDRSB may be expressed as:

$$y ( f ) = H ( f ) ( s ( f ) * {k}_{1} ( f ) + {s}^{*} ( - f ) * {k}_{2} ( f ) ) ,$$

where y(f) may be associated with (nrx, 1), H(f) may be associated with (nrx, ntx), s(f) may be associated with (ntx, 1), k₁(f) may be associated with (ntx, 1), s*(−f) may be associated with (ntx, 1), and k₂(f) may be associated with (ntx, 1). For example, nrx may represent a quantity of receiving antennas, and ntx may represent a quantity of transmitting antennas.

As indicated above, FIGS. 5A-5C are provided as an example. Other examples may differ from what is described with respect to FIGS. 5A-5C.

FIG. 6 is a diagram illustrating an example process 600 performed, for example, at a UE or an apparatus of a UE. Example process 600 is an example where the apparatus or the UE (e.g., UE 120) performs operations associated with FDRSB mitigation.

As shown in FIG. 6, in some aspects, process 600 may include receiving, from a network node, a request for a plurality of FDRSB reports (block 610). For example, the UE (e.g., using reception component 802 or communication manager 806, depicted in FIG. 8) may receive, from a network node, a request for a plurality of FDRSB reports, as described above in connection with FIGS. 4A-5C.

As further shown in FIG. 6, in some aspects, process 600 may include transmitting, to the network node, a first report including a full FDRSB model associated with a first FDRSB estimation (block 620). For example, the UE (e.g., using transmission component 804 or communication manager 806, depicted in FIG. 8) may transmit, to the network node, a first report including a full FDRSB model associated with a first FDRSB estimation, as described above in connection with FIGS. 4A-5C.

As further shown in FIG. 6, in some aspects, process 600 may include transmitting, to the network node, a second report including a partial FDRSB model associated with a second FDRSB estimation (block 630). For example, the UE (e.g., using transmission component 804 or communication manager 806, depicted in FIG. 8) may transmit, to the network node, a second report including a partial FDRSB model associated with a second FDRSB estimation, as described above in connection with FIGS. 4A-5C.

Process 600 may include additional aspects, such as any single aspect or any combination of aspects described below or in connection with one or more other processes described elsewhere herein.

In a first aspect, the request includes an indication of an FDRSB impairment model, and the first FDRSB estimation and the second FDRSB estimation are based at least in part on the FDRSB impairment model.

In a second aspect, alone or in combination with the first aspect, process 600 includes receiving, from the network node prior to receiving the request, a message instructing the UE to indicate one or more FDRSB capabilities, and transmitting, to the network node prior to receiving the request, a message indicating one or more FDRSB estimation capabilities associated with the UE.

In a third aspect, alone or in combination with one or more of the first and second aspects, the request includes a scheduling indication that indicates a plurality of resources for transmitting the first report and the second report.

In a fourth aspect, alone or in combination with one or more of the first through third aspects, the scheduling indication indicates a first transmission, from the network node, associated with the first FDRSB estimation, and a second transmission, from the network node, associated with the second FDRSB estimation.

In a fifth aspect, alone or in combination with one or more of the first through fourth aspects, the scheduling indication indicates one or more of an estimation granularity configuration or a frequency region configuration, each associated with the first FDRSB estimation and with the second FDRSB estimation.

In a sixth aspect, alone or in combination with one or more of the first through fifth aspects, the full FDRSB model includes one or more coefficient values associated with the first FDRSB estimation, and the one or more coefficient values are selected for the full FDRSB model based at least in part on an estimation granularity configuration.

In a seventh aspect, alone or in combination with one or more of the first through sixth aspects, the coefficient values are quantized according to a quantized coding configuration.

In an eighth aspect, alone or in combination with one or more of the first through seventh aspects, process 600 includes receiving, from the network node prior to transmitting the second report, a puncturing configuration, encoding the second FDRSB estimation, and puncturing the encoded second FDRSB estimation, according to the puncturing configuration, to generate the partial FDRSB model.

In a ninth aspect, alone or in combination with one or more of the first through eighth aspects, the partial FDRSB model is associated with a set of parity bits that satisfy an entropy condition associated with the full FDRSB model.

In a tenth aspect, alone or in combination with one or more of the first through ninth aspects, the set of parity bits is located in a first portion of a parity bit segment associated with the full FDRSB model.

In an eleventh aspect, alone or in combination with one or more of the first through tenth aspects, two or more slots, of a plurality of slots associated with the second FDRSB estimation, are encoded according to different code rates indicated by the puncturing configuration.

In a twelfth aspect, alone or in combination with one or more of the first through eleventh aspects, process 600 includes transmitting, to the network node, a third report including an updated partial FDRSB model associated with a third FDRSB estimation.

In a thirteenth aspect, alone or in combination with one or more of the first through twelfth aspects, process 600 includes receiving, from the network node prior to transmitting the third report, an updated puncturing configuration, encoding the third FDRSB estimation, and puncturing the encoded third FDRSB estimation, according to the updated puncturing configuration, to generate the updated partial FDRSB model.

In a fourteenth aspect, alone or in combination with one or more of the first through thirteenth aspects, the partial FDRSB model is associated with a set of parity bits that satisfy an entropy condition associated with the partial FDRSB model.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, at a network node or an apparatus of a network node. Example process 700 is an example where the apparatus or the network node (e.g., network node 110) performs operations associated with FDRSB mitigation.

As shown in FIG. 7, in some aspects, process 700 may include transmitting, to one or more UEs of a set of UEs, a request for a plurality of FDRSB reports (block 710). For example, the network node (e.g., using transmission component 904 or communication manager 906, depicted in FIG. 9) may transmit, to one or more UEs of a set of UEs, a request for a plurality of FDRSB reports, as described above in connection with FIGS. 4A-5C.

As further shown in FIG. 7, in some aspects, process 700 may include receiving, from each UE of the one or more UEs, a first report including a full FDRSB model associated with a first FDRSB estimation (block 720). For example, the network node (e.g., using reception component 902 or communication manager 906, depicted in FIG. 9) may receive, from each UE of the one or more UEs, a first report including a full FDRSB model associated with a first FDRSB estimation, as described above in connection with FIGS. 4A-5C.

As further shown in FIG. 7, in some aspects, process 700 may include receiving, from each UE of the one or more UEs, a second report including a partial FDRSB model associated with a second FDRSB estimation (block 730). For example, the network node (e.g., using reception component 902 or communication manager 906, depicted in FIG. 9) may receive, from each UE of the one or more UEs, a second report including a partial FDRSB model associated with a second FDRSB estimation, as described above in connection with FIGS. 4A-5C.

Process 700 may include additional aspects, such as any single aspect or any combination of aspects described below or in connection with one or more other processes described elsewhere herein.

In a first aspect, process 700 includes applying FDRSB correction based at least in part on one or more of the first report or the second report, from each UE of the one or more UEs.

In a second aspect, alone or in combination with the first aspect, the request includes an indication of an FDRSB impairment model.

In a third aspect, alone or in combination with one or more of the first and second aspects, process 700 includes transmitting, to the set of UEs prior to transmitting the request, a message instructing each UE of the set of UEs to indicate one or more FDRSB capabilities, and receiving, from the one or more UEs prior to transmitting the request, one or more messages indicating one or more FDRSB estimation capabilities associated with each UE of the one or more UEs.

In a fourth aspect, alone or in combination with one or more of the first through third aspects, the request includes a scheduling indication that indicates a plurality of resources for transmitting the first report and the second report.

In a fifth aspect, alone or in combination with one or more of the first through fourth aspects, the scheduling indication indicates a first transmission, from the network node, associated with the first FDRSB estimation, and a second transmission, from the network node, associated with the second FDRSB estimation.

In a sixth aspect, alone or in combination with one or more of the first through fifth aspects, the first transmission and the second transmission are specific to each UE of the one or more UEs.

In a seventh aspect, alone or in combination with one or more of the first through sixth aspects, the scheduling indication indicates one or more of an estimation granularity configuration or a frequency region configuration, each associated with the first FDRSB estimation and with the second FDRSB estimation.

In an eighth aspect, alone or in combination with one or more of the first through seventh aspects, process 700 includes transmitting, to each UE of the one or more UEs, an estimation granularity configuration including conditions for selecting one or more coefficient values, associated with the first FDRSB estimation, for the full FDRSB model.

In a ninth aspect, alone or in combination with one or more of the first through eighth aspects, the coefficient values are quantized according to a quantized coding configuration.

In a tenth aspect, alone or in combination with one or more of the first through ninth aspects, process 700 includes generating a puncturing configuration indicating one or more puncturing parameters for generation of the partial FDRSB model, wherein the puncturing configuration is based on one or more parameters associated with the first report, and transmitting, to each UE of the one or more UEs prior to receiving the second report, the puncturing configuration.

In an eleventh aspect, alone or in combination with one or more of the first through tenth aspects, the one or more parameters associated with the first report include one or more of a time period since receiving the first report, a reliability indicator associated with the first report, or a temperature parameter associated with the time period since receiving the first report.

In a twelfth aspect, alone or in combination with one or more of the first through eleventh aspects, the puncturing configuration indicates a request for a larger quantity of bits to be included in the partial FDRSB model than a quantity of bits included in the full FDRSB model.

In a thirteenth aspect, alone or in combination with one or more of the first through twelfth aspects, the partial FDRSB model is associated with a set of parity bits that satisfy an entropy condition, indicated by the puncturing configuration, associated with the full FDRSB model.

In a fourteenth aspect, alone or in combination with one or more of the first through thirteenth aspects, the set of parity bits is located in a first portion of a parity bit segment associated with the full FDRSB model.

In a fifteenth aspect, alone or in combination with one or more of the first through fourteenth aspects, the puncturing configuration indicates different code rates for encoding two or more slots, of a plurality of slots associated with the second FDRSB estimation.

In a sixteenth aspect, alone or in combination with one or more of the first through fifteenth aspects, process 700 includes concatenating a plurality of LLR segments associated with the partial FDRSB model, and decoding the concatenated LLR segments, wherein the decoded concatenated LLR segments represent a result associated with the second report.

In a seventeenth aspect, alone or in combination with one or more of the first through sixteenth aspects, the plurality of LLR segments includes a plurality of synthetic LLRs associated with decoded data from the full FDRSB model, a plurality of calculated LLRs associated with the partial FDRSB model, and a plurality of zeroed LLRs.

In an eighteenth aspect, alone or in combination with one or more of the first through seventeenth aspects, process 700 includes receiving, from each UE of the one or more UEs, a third report including an updated partial FDRSB model associated with a third FDRSB estimation.

In a nineteenth aspect, alone or in combination with one or more of the first through eighteenth aspects, process 700 includes applying FDRSB correction based at least in part on one or more of the first report, the second report, or the third report, from each UE of the one or more UEs.

In a twentieth aspect, alone or in combination with one or more of the first through nineteenth aspects, process 700 includes generating an updated puncturing configuration indicating one or more puncturing parameters for generation of the updated partial FDRSB model, wherein the updated puncturing configuration is based on one or more parameters associated with the second report, and transmitting, to each UE of the one or more UEs prior to receiving the third report, the updated puncturing configuration.

In a twenty-first aspect, alone or in combination with one or more of the first through twentieth aspects, the updated partial FDRSB model is associated with a set of parity bits that satisfy an entropy condition, indicated by the updated puncturing configuration, associated with the partial FDRSB model.

In a twenty-second aspect, alone or in combination with one or more of the first through twenty-first aspects, the one or more parameters associated with the second report include one or more of a time period since receiving the second report, a reliability indicator associated with the second report, or a temperature parameter associated with the time period since receiving the second report.

In a twenty-third aspect, alone or in combination with one or more of the first through twenty-second aspects, the updated puncturing configuration indicates a request for a larger quantity of bits to be included in the updated partial FDRSB model than a quantity of bits included in the partial FDRSB model.

In a twenty-fourth aspect, alone or in combination with one or more of the first through twenty-third aspects, the updated puncturing configuration indicates a request for a quantity of bits included in the updated partial FDRSB model to be equal to a quantity of bits included in the full FDRSB model, based on a correlation value, associated with the full FDRSB model and the partial FDRSB model, failing to satisfy a correlation threshold.

In a twenty-fifth aspect, alone or in combination with one or more of the first through twenty-fourth aspects, process 700 includes concatenating a plurality of LLR segments associated with the updated partial FDRSB model, and decoding the concatenated LLR segments, wherein the decoded concatenated LLR segments represent a result associated with the third report.

In a twenty-sixth aspect, alone or in combination with one or more of the first through twenty-fifth aspects, the plurality of LLR segments includes a plurality of synthetic LLRs associated with decoded data from the partial FDRSB model, a plurality of calculated LLRs associated with the updated partial FDRSB model, and a plurality of zeroed LLRs.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication. The apparatus 800 may be a UE, or a UE may include the apparatus 800. In some aspects, the apparatus 800 includes a reception component 802, a transmission component 804, or a communication manager 806, which may be in communication with one another (for example, via one or more buses or one or more other components). In some aspects, the communication manager 806 is the communication manager 150 described in connection with FIG. 1. As shown, the apparatus 800 may communicate with another apparatus 808, such as a UE or a network node (such as a CU, a DU, an RU, or a base station), using the reception component 802 and the transmission component 804. The communication manager 806 may be included in, or implemented via, a processing system (for example, the processing system 140 described in connection with FIG. 1) of the UE.

In some aspects, the apparatus 800 may be configured to perform one or more operations described herein in connection with FIG. 4A, 4B, 4C, 4D 5A, 5B, or 5C.

Additionally, or alternatively, the apparatus 800 may be configured to perform one or more processes described herein, such as process 600 of FIG. 6. In some aspects, the apparatus 800 or one or more components shown in FIG. 8 may include one or more components of the UE described in connection with FIG. 1. Additionally, or alternatively, one or more components shown in FIG. 8 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications, and may provide the processed signals to the one or more other components of the apparatus 800. In some aspects, the reception component 802 may include one or more components of the UE described above in connection with FIG. 1, such as a radio, one or more RF chains, one or more transceivers, or one or more modems, each of which may in turn be coupled with one or more antennas of the UE.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications, and may transmit the processed signals to the apparatus 808. In some aspects, the transmission component 804 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 804 may be co-located with the reception component 802.

The communication manager 806 may support operations of the reception component 802 or the transmission component 804. For example, the communication manager 806 may receive information associated with configuring reception of communications by the reception component 802 or transmission of communications by the transmission component 804. Additionally, or alternatively, the communication manager 806 may generate or provide control information to the reception component 802 or the transmission component 804 to control reception or transmission of communications.

The reception component 802 may receive, from a network node, a request for a plurality of FDRSB reports. The transmission component 804 may transmit, to the network node, a first report including a full FDRSB model associated with a first FDRSB estimation. The transmission component 804 may transmit, to the network node, a second report including a partial FDRSB model associated with a second FDRSB estimation.

The reception component 802 may receive, from the network node prior to receiving the request, a message instructing the UE to indicate one or more FDRSB capabilities.

The transmission component 804 may transmit, to the network node prior to receiving the request, a message indicating one or more FDRSB estimation capabilities associated with the UE.

The reception component 802 may receive, from the network node prior to transmitting the second report, a puncturing configuration.

The communication manager 806 may encode the second FDRSB estimation.

The communication manager 806 may puncture the encoded second FDRSB estimation, according to the puncturing configuration, to generate the partial FDRSB model.

The transmission component 804 may transmit, to the network node, a third report including an updated partial FDRSB model associated with a third FDRSB estimation.

The reception component 802 may receive, from the network node prior to transmitting the third report, an updated puncturing configuration.

The communication manager 806 may encode the third FDRSB estimation.

The communication manager 806 may puncture the encoded third FDRSB estimation, according to the updated puncturing configuration, to generate the updated partial FDRSB model.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication. The apparatus 900 may be a network node, or a network node may include the apparatus 900. In some aspects, the apparatus 900 includes a reception component 902, a transmission component 904, or a communication manager 906, which may be in communication with one another (for example, via one or more buses or one or more other components). In some aspects, the communication manager 906 is the communication manager 155 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 145 described in connection with FIG. 1) of the network node.

In some aspects, the apparatus 900 may be configured to perform one or more operations described herein in connection with FIG. 4A, 4B, 4C, 4D, 5A, 5B, or 5C. Additionally, or alternatively, the apparatus 900 may be configured to perform one or more processes described herein, such as process 700 of FIG. 7. In some aspects, the apparatus 900 or one or more components shown in FIG. 9 may include one or more components of the network node described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the network node described above in connection with FIG. 1, such as a radio, one or more RF chains, one or more transceivers, or one or more modems, each of which may in turn be coupled with one or more antennas of the network node. In some aspects, the reception component 902 or the transmission component 904 may include or may be included in a network interface. The network interface may be configured to obtain or output signals for the apparatus 900 via one or more communications links, such as a backhaul link, a midhaul link, or a fronthaul link.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 904 may be co-located with the reception component 902.

The communication manager 906 may support operations of the reception component 902 or the transmission component 904. For example, the communication manager 906 may receive information associated with configuring reception of communications by the reception component 902 or transmission of communications by the transmission component 904. Additionally, or alternatively, the communication manager 906 may generate or provide control information to the reception component 902 or the transmission component 904 to control reception or transmission of communications.

The transmission component 904 may transmit, to one or more UEs of a set of UEs, a request for a plurality of FDRSB reports. The reception component 902 may receive, from each UE of the one or more UEs, a first report including a full FDRSB model associated with a first FDRSB estimation. The reception component 902 may receive, from each UE of the one or more UEs, a second report including a partial FDRSB model associated with a second FDRSB estimation.

The communication manager 906 may apply FDRSB correction based at least in part on one or more of the first report or the second report, from each UE of the one or more UEs.

The transmission component 904 may transmit, to the set of UEs prior to transmitting the request, a message instructing each UE of the set of UEs to indicate one or more FDRSB capabilities.

The reception component 902 may receive, from the one or more UEs prior to transmitting the request, one or more messages indicating one or more FDRSB estimation capabilities associated with each UE of the one or more UEs.

The transmission component 904 may transmit, to each UE of the one or more UEs, an estimation granularity configuration including conditions for selecting one or more coefficient values, associated with the first FDRSB estimation, for the full FDRSB model.

The communication manager 906 may generate a puncturing configuration indicating one or more puncturing parameters for generation of the partial FDRSB model, wherein the puncturing configuration is based on one or more parameters associated with the first report.

The transmission component 904 may transmit, to each UE of the one or more UEs prior to receiving the second report, the puncturing configuration.

The communication manager 906 may concatenate a plurality of LLR segments associated with the partial FDRSB model.

The communication manager 906 may decode the concatenated LLR segments, wherein the decoded concatenated LLR segments represent a result associated with the second report.

The reception component 902 may receive, from each UE of the one or more UEs, a third report including an updated partial FDRSB model associated with a third FDRSB estimation.

The communication manager 906 may apply FDRSB correction based at least in part on one or more of the first report, the second report, or the third report, from each UE of the one or more UEs.

The communication manager 906 may generate an updated puncturing configuration indicating one or more puncturing parameters for generation of the updated partial FDRSB model, wherein the updated puncturing configuration is based on one or more parameters associated with the second report.

The transmission component 904 may transmit, to each UE of the one or more UEs prior to receiving the third report, the updated puncturing configuration.

The communication manager 906 may concatenate a plurality of LLR segments associated with the updated partial FDRSB model.

The communication manager 906 may decode the concatenated LLR segments, wherein the decoded concatenated LLR segments represent a result associated with the third report.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a user equipment (UE), comprising: receiving, from a network node, a request for a plurality of frequency-dependent residual side band (FDRSB) reports; transmitting, to the network node, a first report including a full FDRSB model associated with a first FDRSB estimation; and transmitting, to the network node, a second report including a partial FDRSB model associated with a second FDRSB estimation.

Aspect 2: The method of Aspect 1, wherein the request includes an indication of an FDRSB impairment model, and wherein the first FDRSB estimation and the second FDRSB estimation are based at least in part on the FDRSB impairment model.

Aspect 3: The method of any of Aspects 1-2, further comprising: receiving, from the network node prior to receiving the request, a message instructing the UE to indicate one or more FDRSB capabilities; and transmitting, to the network node prior to receiving the request, a message indicating one or more FDRSB estimation capabilities associated with the UE.

Aspect 4: The method of any of Aspects 1-3, wherein the request includes a scheduling indication that indicates a plurality of resources for transmitting the first report and the second report.

Aspect 5: The method of Aspect 4, wherein the scheduling indication indicates a first transmission, from the network node, associated with the first FDRSB estimation, and a second transmission, from the network node, associated with the second FDRSB estimation.

Aspect 6: The method of Aspect 4, wherein the scheduling indication indicates one or more of an estimation granularity configuration or a frequency region configuration, each associated with the first FDRSB estimation and with the second FDRSB estimation.

Aspect 7: The method of any of Aspects 1-6, wherein the full FDRSB model includes one or more coefficient values associated with the first FDRSB estimation, and wherein the one or more coefficient values are selected for the full FDRSB model based at least in part on an estimation granularity configuration.

Aspect 8: The method of Aspect 7, wherein the coefficient values are quantized according to a quantized coding configuration.

Aspect 9: The method of any of Aspects 1-8, further comprising: receiving, from the network node prior to transmitting the second report, a puncturing configuration; encoding the second FDRSB estimation; and puncturing the encoded second FDRSB estimation, according to the puncturing configuration, to generate the partial FDRSB model.

Aspect 10: The method of Aspect 9, wherein the partial FDRSB model is associated with a set of parity bits that satisfy an entropy condition associated with the full FDRSB model.

Aspect 11: The method of Aspect 10, wherein the set of parity bits is located in a first portion of a parity bit segment associated with the full FDRSB model.

Aspect 12: The method of Aspect 9, wherein two or more slots, of a plurality of slots associated with the second FDRSB estimation, are encoded according to different code rates indicated by the puncturing configuration.

Aspect 13: The method of any of Aspects 1-12, further comprising: transmitting, to the network node, a third report including an updated partial FDRSB model associated with a third FDRSB estimation.

Aspect 14: The method of Aspect 13, further comprising: receiving, from the network node prior to transmitting the third report, an updated puncturing configuration; encoding the third FDRSB estimation; and puncturing the encoded third FDRSB estimation, according to the updated puncturing configuration, to generate the updated partial FDRSB model.

Aspect 15: The method of Aspect 14, wherein the partial FDRSB model is associated with a set of parity bits that satisfy an entropy condition associated with the partial FDRSB model.

Aspect 16: A method of wireless communication performed by a network node, comprising: transmitting, to one or more user equipments (UEs) of a set of UEs, a request for a plurality of frequency-dependent residual side band (FDRSB) reports; receiving, from each UE of the one or more UEs, a first report including a full FDRSB model associated with a first FDRSB estimation; and receiving, from each UE of the one or more UEs, a second report including a partial FDRSB model associated with a second FDRSB estimation.

Aspect 17: The method of Aspect 16, further comprising: applying FDRSB correction based at least in part on one or more of the first report or the second report, from each UE of the one or more UEs.

Aspect 18: The method of any of Aspects 16-17, wherein the request includes an indication of an FDRSB impairment model.

Aspect 19: The method of any of Aspects 16-18, further comprising: transmitting, to the set of UEs prior to transmitting the request, a message instructing each UE of the set of UEs to indicate one or more FDRSB capabilities; and receiving, from the one or more UEs prior to transmitting the request, one or more messages indicating one or more FDRSB estimation capabilities associated with each UE of the one or more UEs.

Aspect 20: The method of any of Aspects 16-19, wherein the request includes a scheduling indication that indicates a plurality of resources for transmitting the first report and the second report.

Aspect 21: The method of Aspect 20, wherein the scheduling indication indicates a first transmission, from the network node, associated with the first FDRSB estimation, and a second transmission, from the network node, associated with the second FDRSB estimation.

Aspect 22: The method of Aspect 21, wherein the first transmission and the second transmission are specific to each UE of the one or more UEs.

Aspect 23: The method of Aspect 20, wherein the scheduling indication indicates one or more of an estimation granularity configuration or a frequency region configuration, each associated with the first FDRSB estimation and with the second FDRSB estimation.

Aspect 24: The method of any of Aspects 16-23, further comprising: transmitting, to each UE of the one or more UEs, an estimation granularity configuration including conditions for selecting one or more coefficient values, associated with the first FDRSB estimation, for the full FDRSB model.

Aspect 25: The method of Aspect 24, wherein the coefficient values are quantized according to a quantized coding configuration.

Aspect 26: The method of any of Aspects 16-25, further comprising:

generating a puncturing configuration indicating one or more puncturing parameters for generation of the partial FDRSB model, wherein the puncturing configuration is based on one or more parameters associated with the first report; and transmitting, to each UE of the one or more UEs prior to receiving the second report, the puncturing configuration.

Aspect 27: The method of Aspect 26, wherein the one or more parameters associated with the first report include one or more of a time period since receiving the first report, a reliability indicator associated with the first report, or a temperature parameter associated with the time period since receiving the first report.

Aspect 28: The method of Aspect 26, wherein the puncturing configuration indicates a request for a larger quantity of bits to be included in the partial FDRSB model than a quantity of bits included in the full FDRSB model.

Aspect 29: The method of Aspect 26, wherein the partial FDRSB model is associated with a set of parity bits that satisfy an entropy condition, indicated by the puncturing configuration, associated with the full FDRSB model.

Aspect 30: The method of Aspect 29, wherein the set of parity bits is located in a first portion of a parity bit segment associated with the full FDRSB model.

Aspect 31: The method of Aspect 26, wherein the puncturing configuration indicates different code rates for encoding two or more slots, of a plurality of slots associated with the second FDRSB estimation.

Aspect 32: The method of any of Aspects 16-31, further comprising: concatenating a plurality of log-likehood ratio (LLR) segments associated with the partial FDRSB model; and decoding the concatenated LLR segments, wherein the decoded concatenated LLR segments represent a result associated with the second report.

Aspect 33: The method of Aspect 32, wherein the plurality of LLR segments includes a plurality of synthetic LLRs associated with decoded data from the full FDRSB model, a plurality of calculated LLRs associated with the partial FDRSB model, and a plurality of zeroed LLRs.

Aspect 34: The method of any of Aspects 16-33, further comprising: receiving, from each UE of the one or more UEs, a third report including an updated partial FDRSB model associated with a third FDRSB estimation.

Aspect 35: The method of Aspect 34, further comprising: applying FDRSB correction based at least in part on one or more of the first report, the second report, or the third report, from each UE of the one or more UEs.

Aspect 36: The method of Aspect 34, further comprising: generating an updated puncturing configuration indicating one or more puncturing parameters for generation of the updated partial FDRSB model, wherein the updated puncturing configuration is based on one or more parameters associated with the second report; and transmitting, to each UE of the one or more UEs prior to receiving the third report, the updated puncturing configuration.

Aspect 37: The method of Aspect 36, wherein the updated partial FDRSB model is associated with a set of parity bits that satisfy an entropy condition, indicated by the updated puncturing configuration, associated with the partial FDRSB model.

Aspect 38: The method of Aspect 36, wherein the one or more parameters associated with the second report include one or more of a time period since receiving the second report, a reliability indicator associated with the second report, or a temperature parameter associated with the time period since receiving the second report.

Aspect 39: The method of Aspect 36, wherein the updated puncturing configuration indicates a request for a larger quantity of bits to be included in the updated partial FDRSB model than a quantity of bits included in the partial FDRSB model.

Aspect 40: The method of Aspect 36, wherein the updated puncturing configuration indicates a request for a quantity of bits included in the updated partial FDRSB model to be equal to a quantity of bits included in the full FDRSB model, based on a correlation value, associated with the full FDRSB model and the partial FDRSB model, failing to satisfy a correlation threshold.

Aspect 41: The method of Aspect 34, further comprising: concatenating a plurality of LLR segments associated with the updated partial FDRSB model; and decoding the concatenated LLR segments, wherein the decoded concatenated LLR segments represent a result associated with the third report.

Aspect 42: The method of Aspect 41, wherein the plurality of LLR segments includes a plurality of synthetic LLRs associated with decoded data from the partial FDRSB model, a plurality of calculated LLRs associated with the updated partial FDRSB model, and a plurality of zeroed LLRs.

Aspect 43: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-42.

Aspect 44: An apparatus for wireless communication at a device, the apparatus comprising one or more memories and one or more processors coupled to the one or more memories, the one or more processors configured to cause the device to perform the method of one or more of Aspects 1-42.

Aspect 45: An apparatus for wireless communication, the apparatus comprising at least one means for performing the method of one or more of Aspects 1-42.

Aspect 46: A non-transitory computer-readable medium storing code for wireless communication, the code comprising instructions executable by one or more processors to perform the method of one or more of Aspects 1-42.

Aspect 47: A non-transitory computer-readable medium storing a set of instructions for wireless communication, the set of instructions comprising one or more instructions that, when executed by one or more processors of a device, cause the device to perform the method of one or more of Aspects 1-42.

Aspect 48: A device for wireless communication, the device comprising a processing system that includes one or more processors and one or more memories coupled with the one or more processors, the processing system configured to cause the device to perform the method of one or more of Aspects 1-42.

Aspect 49: An apparatus for wireless communication at a device, the apparatus comprising one or more memories and one or more processors coupled to the one or more memories, the one or more processors individually or collectively configured to cause the device to perform the method of one or more of Aspects 1-42.

Aspect 50: A device comprising a processing system that includes one or more processors and one or more code-storing memories coupled with the one or more processors, the processing system configured to cause the device to perform the method of one or more of Aspects 1-42.

Aspect 51: A device comprising a processing system that includes processor circuitry and code-storing memory circuitry, the processing system configured to cause the device to perform the method of one or more of Aspects 1-42.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
a processing system that includes one or more processors and one or more code-storing memories coupled with the one or more processors, the processing system configured to cause the UE to:
receive, from a network node, a request for a plurality of frequency-dependent residual side band (FDRSB) reports;
transmit, to the network node, a first report including a full FDRSB model associated with a first FDRSB estimation; and
transmit, to the network node, a second report including a partial FDRSB model associated with a second FDRSB estimation.

2. The UE of claim 1, wherein the request includes an indication of an FDRSB impairment model, and wherein the first FDRSB estimation and the second FDRSB estimation are based at least in part on the FDRSB impairment model.

3. The UE of claim 1, wherein the processing system is configured to cause the UE to:
receive, from the network node prior to receiving the request, a message instructing the UE to indicate one or more FDRSB capabilities; and
transmit, to the network node prior to receiving the request, a message indicating one or more FDRSB estimation capabilities associated with the UE.

4. The UE of claim 1, wherein the request includes a scheduling indication that indicates a plurality of resources for transmitting the first report and the second report.

5. The UE of claim 4, wherein the scheduling indication indicates a first transmission, from the network node, associated with the first FDRSB estimation, and a second transmission, from the network node, associated with the second FDRSB estimation.

6. The UE of claim 4, wherein the scheduling indication indicates one or more of an estimation granularity configuration or a frequency region configuration, each associated with the first FDRSB estimation and with the second FDRSB estimation.

7. The UE of claim 1, wherein the full FDRSB model includes one or more coefficient values associated with the first FDRSB estimation, and wherein the one or more coefficient values are selected for the full FDRSB model based at least in part on an estimation granularity configuration.

8. The UE of claim 7, wherein the coefficient values are quantized according to a quantized coding configuration.

9. The UE of claim 1, wherein the processing system is configured to cause the UE to:
receive, from the network node prior to transmitting the second report, a puncturing configuration;
encode the second FDRSB estimation; and
puncture the encoded second FDRSB estimation, according to the puncturing configuration, to generate the partial FDRSB model.

10. The UE of claim 1, wherein the processing system is configured to cause the UE to:
transmit, to the network node, a third report including an updated partial FDRSB model associated with a third FDRSB estimation.

11. The UE of claim 10, wherein the processing system is configured to cause the UE to:
receive, from the network node prior to transmitting the third report, an updated puncturing configuration;
encode the third FDRSB estimation; and
puncture the encoded third FDRSB estimation, according to the updated puncturing configuration, to generate the updated partial FDRSB model.

12. A network node, comprising:
a processing system that includes one or more processors and one or more code-storing memories coupled with the one or more processors, the processing system configured to cause the network node to:
transmit, to one or more user equipments (UEs) of a set of UEs, a request for a plurality of frequency-dependent residual side band (FDRSB) reports;
receive, from each UE of the one or more UEs, a first report including a full FDRSB model associated with a first FDRSB estimation; and
receive, from each UE of the one or more UEs, a second report including a partial FDRSB model associated with a second FDRSB estimation.

13. The network node of claim 12, wherein the processing system is configured to cause the network node to:
transmit, to the set of UEs prior to transmitting the request, a message instructing each UE of the set of UEs to indicate one or more FDRSB capabilities; and
receive, from the one or more UEs prior to transmitting the request, one or more messages indicating one or more FDRSB estimation capabilities associated with each UE of the one or more UEs.

14. The network node of claim 12, wherein the request includes a scheduling indication that indicates a plurality of resources for transmitting the first report and the second report.

15. The network node of claim 14, wherein the scheduling indication indicates a first transmission, from the network node, associated with the first FDRSB estimation, and a second transmission, from the network node, associated with the second FDRSB estimation.

16. The network node of claim 12, wherein the processing system is configured to cause the network node to:
generate a puncturing configuration indicating one or more puncturing parameters for generation of the partial FDRSB model, wherein the puncturing configuration is based on one or more parameters associated with the first report; and
transmit, to each UE of the one or more UEs prior to receiving the second report, the puncturing configuration.

17. The network node of claim 12, wherein the processing system is configured to cause the network node to:
concatenate a plurality of log-likehood ratio (LLR) segments associated with the partial FDRSB model; and
decode the concatenated LLR segments, wherein the decoded concatenated LLR segments represent a result associated with the second report.

18. The network node of claim 12, wherein the processing system is configured to cause the network node to:
receive, from each UE of the one or more UEs, a third report including an updated partial FDRSB model associated with a third FDRSB estimation.

19. The network node of claim 18, wherein the processing system is configured to cause the network node to:
apply FDRSB correction based at least in part on one or more of the first report, the second report, or the third report, from each UE of the one or more UEs.

20. A method of wireless communication performed by a user equipment (UE), comprising:
receiving, from a network node, a request for a plurality of frequency-dependent residual side band (FDRSB) reports;
transmitting, to the network node, a first report including a full FDRSB model associated with a first FDRSB estimation; and
transmitting, to the network node, a second report including a partial FDRSB model associated with a second FDRSB estimation.
